(19) United States
(12) Patent Application Publication
(10) Pub. No.: US 2010/0110741 A1
(43) Pub. Date: May 6, 2010

(54) MINIATURE HIGH VOLTAGE/CURRENT AC SWITCH USING LOW VOLTAGE SINGLE SUPPLY CONTROL

(75) Inventors: Jenshan Lin, Gainesville, FL (US); Zhen Ning Low, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(73) Assignee: University of Florida Research Foundation, Inc., Gainesville, FL (US)

(21) Appl. No.: 12/263,178

(22) Filed: Oct. 31, 2008

(51) Int. Cl. H02M 7/217

(52) U.S. Cl. 363/127

(57) ABSTRACT

Embodiments of the invention pertain to a method and apparatus for planar wireless power transfer where the receiver switches off and/or performs a duty cycle. In an embodiment, the switch can be used in a system that having a high voltage/current solid state switch, without having a high voltage control signal. An embodiment provides a switch that is capable of breaking, or greatly reducing, the connection of the receiver coil and the receiver circuitry in order to enable the receiver to decouple from the power transfer system. This embodiment can allow the transmitter to put out more power to other devices without providing power to the switched device. When the switch is used for a fully charged device, the switching can prevent or reduce damage to the fully charged device.

### BACKGROUND OF INVENTION

Recently, the emergent of various wireless power technology to eliminate the “last cable” has generated significant research interest. Wireless power systems can be classified into two main categories, medium to long range, where the coverage is greater or equal to a typical Personal Area Network (PAN), and short range, where the coverage is localized within the vicinity of the transmitting device (typically a 5″ distance). Attempts have been made to achieve long range power delivery via far-field techniques have not been successful. The efficiency and power delivery is insufficient to fully charge even a typical portable device overnight at a comfortable distance. Such systems are only viable for extending battery life or to power extremely low power devices such as Zigbee sensor nodes. In order to provide power comparable to a typical wall mounted DC supply, the system would violate RF safety regulations (IEEE Std C95.1, 2005 Edition, IEEE Standard for Safety Levels with Respect to Human Exposure to Radio Frequency Electromagnetic Fields, 3 kHz to 300 GHz), or has to use a large number of transmitters resulting in an impractical and costly implementation. Therefore, far-field techniques are most suitable for very low power applications unless they are used in less regulated environments such as military or space exploration.

Inductive coupling has been one of the leading candidates in achieving wireless power transfer at power levels ranging from several microwatts to hundreds of watts. Its operating range is limited as power delivery and efficiency degrades rapidly with increasing distance between the transmitting and receiving unit. Using near-field operation at frequencies below 1 MHz significantly lowers the probability of interference and RF safety issues since the wavelength is extremely long and radiation is limited. However, unlike far-fields techniques, near-field techniques are extremely sensitive to the loading the condition of the receiver(s) as well as the number of receivers. Limited studies have been done on analyzing the power delivery of an inductive coupling system to multiple receiving units via a single transmitting unit. Although (X. Liu, S. Y. R Hui, “Optimal design of a hybrid winding structure for planar contactless battery charging platform,” IEEE Transactions on Power Electronics, vol. 23, pp. 455-463, January 2008) shows the potential of supporting multiple receivers on a single transmitting platform, analysis of the power delivery is not presented. The block diagram of the multiple receivers wireless power system using inductive coupling is shown in FIG. 1*.

Traditionally the preferred choice of a driving circuit is the half bridge or full bridge inverter via ZPA (Zero Phase Angle) operation. ZPA can be achieved with either frequency control or a variable tank circuit at the transmitter load network. Both techniques can be employed to extend the high efficiency and stable operating range across a wide range of load resistance. Recent papers proposed the use of the Class E mode of operation as an alternative. Fundamentally, the Class E mode of operation works with tight operations to achieve ZVS (Zero Voltage switching) as well as ZDS (Zero Derivative Switching). Therefore, it is commonly considered important to keep the operation of the Class E transistor within its operational bounds as any significant deviation may lead to failure of the transmitter.

Delivering power to a device with a high efficiency switching regulator at the input of the device can be challenging. This is because a typical buck switching regulator, requiring a higher input voltage to operate, tends to “amplify” the load resistance. The “amplification” of load resistance will tend to “choke” the other receivers in a multiple receivers setup especially when one of the receiver is in a high resistance/trickle charge state. The switching buck regulator will attempt to maintain its power delivery by increasing its input resistance or decrease its duty cycle resulting in a positive feedback. Poor efficiency will be observed due to excess power dissipated as heat and device failure may occur due to over voltage. In order to achieve considerable power delivery when one of the receiving devices is fully change, it needs to decouple itself from the system. The decoupling can be achieved by a switch. Since the receiver will most probably be used for portable electronics, the switch needs to be compact and be controlled using a low voltage e.g. 3V or less.

The regulator input resistance can be several ohms at a high power charging state or thousands of ohms during trickle charge state. In addition, developing a robust control system to avoid the bifurcation phenomena [12-14] can increase the complexity of the system significantly.

A planar wireless power system that is powering multiple loads might not be able to deliver sufficient power to all devices to maintain the nominal charge rate, especially when one or more of the devices is fully charged. The fully charged device may cause the transmitter to tune down its output power to prevent the condition of over voltage. This in turn may cause the other devices to charge slower. Accordingly, it would be advantageous to provide a mechanism for decoupling a receiver's circuitry from the receiver's coil in order to decouple the receiver from the power transfer system in certain situations, such as when the device incorporating the receiver is fully charged.

In order to fully decouple a receiver of a planar near field wireless power system, or to perform duty cycle to reduce power delivery, a switch is commonly used to break the connection between the receiving coil and the receiver circuitry. The AC voltage at the receiving coil (e.g., 30-40Vpp) is larger than the control voltage from many receiving devices (e.g., cell phone/mp 3 player, and/or 3VDC). Therefore, a voltage boost circuit and inverting circuit is typically used to provide sufficient control voltage to switch a solid state switch. This can make the circuit large, complicated, and costly.

### BRIEF SUMMARY

Embodiments of the invention relate to a method and a high-efficiency wireless power transfer system that is capable of supporting more than one receiver via inductive coupling. The wireless power transfer system can use a class E operation for the transmitter and a decoupling switch. The system can operate without a complex external control system, by relying on the system's natural impedance response to achieve the desired power delivery profile across a wide range of load resistances, while maintaining high efficiency to prevent any heating issues. A switch architecture can be used to “decouple” the fully charged receiver or from the system so that power delivery to the other receiver or receivers can be improved. The system can be designed to deliver power to portable electronics, such as cellular phones, PDA's, mp 3 players. A specific embodiment of the subject system is compact and capable of nearly 2.5 W of power delivery to each of the two receivers in a dual receiver setup, and capable of delivering 5W to a single receiver alone or to a receiver when the other receiver is “decoupled” by a receiver switch. During high power delivery state, the system efficiency can be kept between 67.5% and 77.5%. Higher power delivery can be achieved by increasing the supply voltage and using higher power components.

Embodiments of the invention relate to a method and apparatus to rectify the input AC voltage to obtain a large positive and negative voltage to be used as a switch control signal. A specific embodiment of a circuit for rectifying the input AC voltage is shown in FIG. 6A. The AC out can be further rectified to provide a DC voltage with minimum ripples (not shown in FIG. 6A). The embodiment of the switch shown in FIG. 6A uses a transmission gate having a PMOS transistor and a NMOS transistor in parallel. The two diodes in series with the transmission gate's transistors are used to remove the effect of the built-in diode of the transistors. The other two diodes connected directly to the AC input node are used to rectify the input waveform. The additional capacitors and resistors (C1_{—}1, C2_{—}1, R1_{—}1, C1_{—}2, C2_{—}2, and R1_{—}2) are used to smooth the rectified waveform to a DC value. The positive voltage rectification network, at the bottom of the FIG. 6A, is used to generate the positive switch control signal, while the negative voltage rectification network, at the top of FIG. 6A, is used to generate the negative switch voltage. The values of the capacitors and resistors of the rectification networks can be optimized for switching speed and/or bootstrapping time.

### BRIEF DESCRIPTION OF DRAWINGS

FIG. 1 Block diagram of the multiple receivers wireless power transfer system using inductive coupling.

FIG. 2 Topologies for a single-element impedance transformation network.

FIG. 3 shows a simplified schematic of wireless power transfer system using series-parallel transformation network and Class E transmitter in accordance with an embodiment of the invention.

FIG. 4 shows a bootstrapping mode waveforms in accordance with an embodiment of the subject invention.

FIG. 5 shows a block diagram of an embodiment of a switch in accordance with the subject invention.

FIGS. 6A-6D show a schematic of an embodiment of a switch circuit in accordance with the subject invention.

FIG. 7 shows a schematic of an embodiment of a switch circuit in accordance with the subject invention, and the operating states of the same switch circuit.

FIG. 8 Schematic of the switch in Advanced System Design with a loaded full wave rectifier as load.

FIG. 9 shows a switch control waveform (0V for off and 3V for on), where a minimum of 1 V is required to turn on the transistor.

FIG. 10 shows a generated switch control waveform for channel 1 (P channel MOSFET of the transmission gate) and a generated switch control waveform for channel 2 (N channel MOSFET of the transmission gate).

FIG. 11 shows an output waveform of the switch before the rectifier.

FIG. 12 shows a rectified waveform of an embodiment of a switch.

FIG. 13A shows a half-wave rectifier receiver architecture in accordance with the subject invention.

FIG. 13B shows a half-wave rectifier receiver architecture in accordance with the subject invention.

FIG. 14 Windings of a 20 cm×20 cm transmitting coil used for experimental verification.

FIG. 15 Normalized power deliver with respect to location of transmitting coil in FIG. 14 using a receiving coil of 9 cm×6 cm.

FIG. 16 shows the resistance and reactance of Zᵣₓ versus load resistance with different Cᵣₓ (50 nF, 100 nF and 150 nF) for an embodiment of the invention.

FIG. 17 shows the peak resistance response looking into the transmitting coil with respect to Cᵣₓ for an embodiment of the invention.

FIG. 18 shows resistance and reactance looking into the transmitting coil with receiver capacitance of 73 nF and 97 nF for an embodiment of the invention.

FIG. 19 shows the coupling efficiency with respect to load resistance for an embodiment of the invention.

FIG. 20 shows Z_{tX} phase response with respect to load resistance for various Cₒᵤₜ capacitance value for an embodiment of the invention.

FIG. 21 shows transistor drain voltage waveform for different load resistance. Cₛₕᵤₙₜ=10 nF) for an embodiment of the invention.

FIG. 22 shows a photograph of a fabricated transmitter in accordance with the invention.

FIG. 23 shows a photograph of a fabricated receiver in accordance with the invention.

FIG. 24 shows a photograph of a setup with two receivers on the packaged transmitting coil in accordance with the invention.

FIG. 25 shows a photograph of test bench.

FIG. 26 shows a waveform of class E transmitter circuit, where channel one: Drain voltage, Channel three: Coil voltage, Channel four: Coil current.

FIG. 27 shows a spectrum of the transmitter's coil current with 2^{nd} harmonic 23.6 dB lower than the fundamental tone.

FIG. 28 shows power delivery to the receiver with switch with respect to load resistance for a 1 to 1 setup (simulated and measured).

FIG. 29 shows system efficiency with respect to load resistance for a 1 to 1 setup (simulated and measured).

FIG. 30 shows input power to the transmitter with respect to load resistance (simulated and measured).

FIG. 31 shows efficiency of power delivery to the receiver with switch with respect to power delivered for a 1 to 1 setup (Both simulated and measured).

FIG. 32 shows a comparison between receiver with switch and receiver without switch.

FIG. 33 shows a comparison between single receiver standalone and dual receiver setup with one receiver switched off.

FIG. 34 shows a power delivery to the receiver 1 with respect to its load resistance for a dual receiver test bench while keeping the receiver 2 load resistance fixed.

FIG. 35 shows a power delivery to receiver 2 with its load resistance fixed with respect to the load resistance of receiver 1 for a dual receiver test bench.

FIG. 36 shows a system efficiency with respect to total power delivery to both receivers the load resistance of receiver 2 fixed and the load resistance of receiver 1 swept across the stated range for a dual receiver test bench.

FIG. 37 shows a comparison between the simulated and measured results of power delivered to receiver 1.

FIG. 38 shows a comparison between the simulated and measured results of power delivered to receiver 2.

FIG. 39 shows a comparison of the simulated system efficiency and measured system efficiency.

FIG. 40 shows simulated power delivery to a dual receiver system with load resistance range from 1Ω to 1000Ω.

FIG. 41 shows simulated power delivery to a dual receiver system with load resistance range from 5Ω to 1000Ω.

FIG. 42 shows simulated power delivery to a dual receiver system with load resistance range from 10Ω to 1000Ω.

FIG. 43 shows simulated power delivery to a dual receiver system with load resistance range from 20Ω to 1000Ω.

FIG. 44 shows measured power delivery to a dual receiver system with load resistance range from 10Ω to 1000Ω.

### DETAILED DISCLOSURE

Embodiments of the invention pertain to a method and apparatus for planar wireless power transfer where the receiver switches off and/or performs a duty cycle. In an embodiment, the switch can be used in a system that having a high voltage/current solid state switch, without having a high voltage control signal.

An embodiment provides a switch that is capable of breaking, or greatly reducing, the connection of the receiver coil and the receiver circuitry in order to enable the receiver to decouple from the power transfer system. This embodiment can allow the transmitter to put out more power to other devices without providing power to the switched device. When the switch is used for a fully charged device, the switching can prevent or reduce damage to the fully charged device.

Embodiments of the invention relate to an efficient wireless power transfer system. Specific embodiments can use the Class E mode of operation for the transmitter. Other modes of operation for the transmitter can also be used. Specific embodiments pertain to a wireless power system having a natural response without any external control or feedback from the receiver to the transmitter. With specific embodiments, the power delivery property closely matches a typical wall mounted DC supply and is transparent to the receiving device. Embodiments can incorporate a receiver switch architecture to handle both high voltage and current via a low voltage control signal. Advantages of various embodiments include achieving high efficiency, while delivering the required power with respect to the load resistance, and decreasing the transmitted power when the load impedance increases.

The subject wireless power transfer system can provide a significant amount of translational freedom such that the power transfer is insensitive to the placement of the device having the receiver coil with respect to the transmitter having the transmitter coil or coils. In addition, the system can concurrently power or charge multiple devices, providing convenience for users of portable wireless devices. Each receiving device can incorporate a decoupling switch that decouples the variable load from the receiver coil to stop charging the variable load when, for example, the variable load is fully charged. In specific embodiments, the receiving coil is significantly smaller than the transmitting coil, resulting in coupling that is generally weak/loose with a coupling coefficient of less than 0.5, and in a further specific embodiment less than 0.25. Under this condition, the interaction between the coils behave as an ideal transformer. In alternative embodiments, the coupling coefficient can be higher than 0.25. In further specific embodiments, the coupling coefficient can be at least 0.05, and further at least 0.1. Embodiments of the system can achieve a desirable power delivery response across a wide range of load resistances without any control mechanism or feedback loop from the receiver to the transmitter. A specific embodiment is an efficient compact wireless power system achieving 5 W of power delivery to a single receiver and close to 2.5 W of power delivery to each receiver for a dual receiver setup in regardless of the load resistance of the other receiver and with better than 75% end-to-end DC-to-DC conversion efficiency across the main power delivery impedance range without external cooling. The system can be used to provide power wirelessly to multiple portable devices concurrently for consumer electronics, industrial appliances, and many other applications. Power delivery can be easily increased by increasing the supply voltage and using higher power components.

Power transfer for a specific embodiment of the system is achieved via magnetic induction between two air core coils. Appropriate shielding can be used to make the system more robust in environments where the system's magnetic field is likely to interact with other nearby objects.

Although having both the transmitting coil and the receiving coil to be of the same size would ensure coupling, specific embodiments use a receiver coil significantly smaller than the transmitting coil. This allows a user to freely place a receiver device in any orientation as well as to place multiple receiver devices on the transmitting coil as shown in FIG. 24. Therefore, in order to achieve consistent power delivery regardless of the receiving coil's location, the transmitting coil should preferably be able to generate a magnetic field that has relatively even distribution. This can be achieved by using, for example, the method (X, Liu, S. Y. R. Hui, “An Analysis of a Double-layer Electromagnetic Shield for a Universal Contactless Battery Charging Platform,” in Proc. IEEE 36^{th} Power Electronics Specialists Conference, 16^{th} June 2005, pp. 1767-1772. and X. Liu, S. Y. R Hui, “Optimal design of a hybrid winding structure for planar contactless battery charging platform,” IEEE Transactions on Power Electronics, vol. 23, pp. 455-463, January 2008), which are hereby incorporated by reference for their teaching of transmitting coil magnetic field generation.

The voltage and current characteristics of the transmitting coil and the receiving coil can be described using the following equations [7] [12]:

V₁=jωM₁₁I₁+jωM₁₂I₂ (1)

V₂=jωM₂₁I₁+jωM₂₂I₂ (2)

M₁₂=k\sqrt{M₁₁M₂₂} (3)

### Where

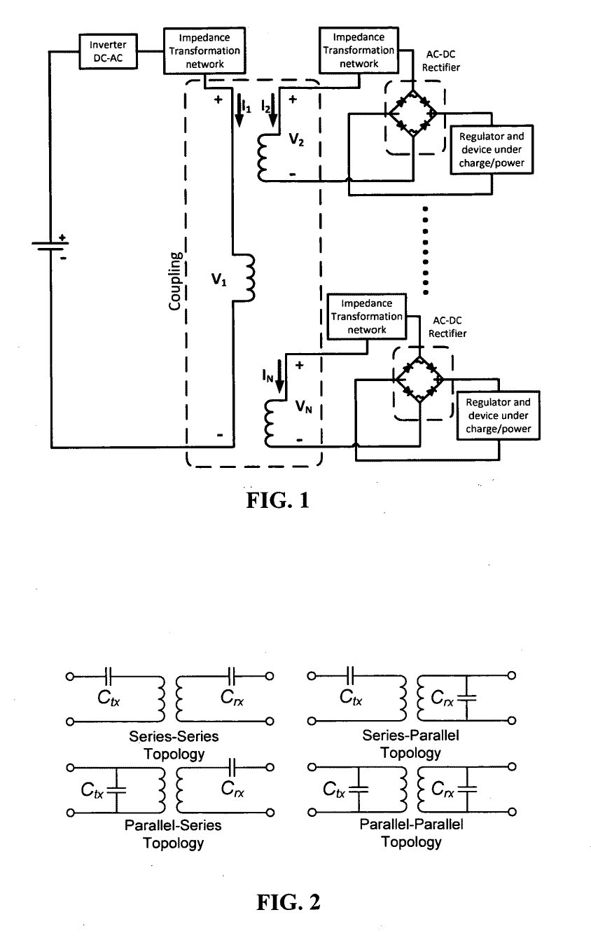

V₁ is the voltage at the transmitting coil (FIG. 1)
I₁ is the current at the transmitting coil (FIG. 1)
V₂ is the voltage at the receiving coil (FIG. 1)
I₂ is the current at the receiving coil (FIG. 1)
M₁₁ is the self inductance of the transmitting coil
M₂₂ is the self inductance of the receiving coil
M₁₂=M₂₁, is the mutual inductance of the two coils
k is the coupling coefficient between the two coils

### By Ohm's law:

$$\begin{matrix}\begin{matrix}{Z}_{tx} = {R}_{tx} + j {X}_{tx} \\ = \frac{{V}_{1}}{{I}_{1}}\end{matrix} & ( 4 ) \\ \begin{matrix}{Z}_{rx} = {R}_{rx} + j {X}_{rx} \\ = \frac{{V}_{2}}{{I}_{2}}\end{matrix} & ( 5 )\end{matrix}$$

Using equations (1, 2 and 4) and assuming a time-harmonic operation with frequency ω.

$${Z}_{tx} = \frac{{ω}^{2} {M}_{12}^{2} {R}_{rx}}{{R}_{rx}^{2} + {( ω {M}_{22} + {X}_{rx} )}^{2}} + j ( ω {M}_{11} - \frac{{ω}^{2} {M}_{12}^{2} ( ω {M}_{22} + {X}_{rx} )}{{R}_{rx}^{2} + {( ω {M}_{22} + {X}_{rx} )}^{2}} ) \qquad ( 6 )$$

Since the receivers are intended to be integrated into portable devices, it is unlikely that the receivers will be overlapped. Therefore, the mutual inductance between the receiving coils can be neglected as the coupling between the receiving coils will typically be significantly weaker than the coupling between the transmitting coil and receiving coils.

$$\begin{matrix}{V}_{1} = j ω {M}_{11} {I}_{1} + j ω {\sum }_{N = 1}^{X} {M}_{1 N} {I}_{N} & ( 7 ) \\ {V}_{N} = {M}_{N 1} {I}_{1} + j ω {M}_{NN} {I}_{N} & ( 8 ) \\ {M}_{1 N} = {k}_{N} \sqrt{{M}_{11} {M}_{NN}} & ( 9 )\end{matrix}$$

### Where

V₁ is the voltage at the transmitting coil (FIG. 1)
I₁ is the current at the transmitting coil (FIG. 1)
V_{N} is the voltage at N receiving coil (FIG. 1)
I_{N} is the current at N receiving coil (FIG. 1)
M₁₁ is the self inductance of the transmitting coil
M_{NN} is the self inductance of N receiving coil
M_{1N}=M_{N1} is the mutual inductance of the transmitting coil and N^{th} receiving coil
k_{N} is the coupling coefficient between the transmitting coil and N^{th} receiving coil

### By Ohm's law:

$$\begin{matrix}\begin{matrix}{Z}_{tx} = {R}_{tx} + j {X}_{tx} \\ = \frac{{V}_{1}}{{I}_{1}}\end{matrix} & ( 10 ) \\ \begin{matrix}{Z}_{rxN} = {R}_{rxN} + j {X}_{rxN} \\ = \frac{{V}_{N}}{{I}_{N}}\end{matrix} & ( 11 )\end{matrix}$$

Using equations (7, 8 and 10) and assuming a time-harmonic operation with frequency ω.

$${Z}_{tx} = {\sum }_{N = 1}^{X} \frac{{ω}^{2} {M}_{1 N}^{2} {R}_{rxN}}{{R}_{rxN}^{2} + {( ω {M}_{NN} + {X}_{rxN} )}^{2}} + j ( ω {M}_{11} - {\sum }_{N = 1}^{X} \frac{{ω}^{2} {M}_{1 N}^{2} ( ω {M}_{NN} + {X}_{rxN} )}{{R}_{rxN}^{2} + {( ω {M}_{NN} + {X}_{rxN} )}^{2}} ) \qquad ( 12 )$$

The above analysis of the coupling neglects any 2^{nd} order effects such as skin depth and proximity effects. Litz wires can be used to mitigate such effects.

An impedance transformation network can be utilized on the primary and secondary sides of the coupling is to achieve maximum power transmission and efficiency by operating within the optimum impedance range looking into the transmitter load network [23] over a wide range of load resistance.

In consideration of size and efficiency, capacitors instead of resistors and inductors can be used for the network. This is because resistors dissipate power and the size of a low loss inductor is generally large. Although, a multi-element transformation network might achieve a better response, for simplicity and low component count, the system can use a single-element transformation network. The four possible topologies of the single-element transformation network are shown in FIG. 2.

Fundamentally, a series capacitor only introduces a negative reactance and does not change the real part of the impedance. On the other hand, a parallel capacitor changes both the real and imaginary parts of the impedance. To simplify the analysis, the receiver input impedance can be modeled using a variable resistor load and equation (13) illustrates the transformation performed by the parallel capacitor.

$${Z}_{rx} = \frac{R}{1 + {ω}^{2} {C}^{2} {R}^{2}} - j \frac{ω {CR}^{2}}{1 + {ω}^{2} {C}^{2} {R}^{2}} \qquad ( 13 )$$

Equation (13) shows that the resistance Rᵣₓ is “compressed” by a factor of 1/(1+ω²C²R²). Thus, the equivalent resistance Rᵣₓ decreases with increasing load resistance. At high load resistance, the transformed resistance is small. Therefore, a significant part of the received power is dissipated across the receiving coil as heat. This phenomenon is desirable if the receiver is in a state that requires very little power or during trickle charge. Therefore, it has a “decoupling” effect regulating the power delivery with increasing load resistance. However, this should occur if and only if the transmitter is designed to output limited power under this operation condition because heating can become a problem if too much power is being dissipated across the receiving coil. Due to the parallel capacitor, a reactive term jXᵣₓ is introduced. The reactive term decreases nonlinearly from null with increasing load resistance with an asymptote of −1/ωC This can be useful to compensate the receiving coil inductance.

From equation (13) it can be observed that the resistance looking into the transmitter coil Rₜₓ is reduced significantly if the resistance looking from the receiver coil into the receiver Rᵣₓ is increased. Due to loose coupling between the coils, Rₜₓ is further reduced because the mutual inductance is relatively small. If the total resistance looking into the transmitting coil is mainly the parasitic resistance of the transmitting coil, limited power is transmitted to the receiver as most of the power is dissipated across the transmitting coil as heat. Therefore, it is preferred for a wireless power transmission system using loosely coupled coils to have a parallel capacitor on the receiving coil. By substituting equation (6) into equation (13), the expression of impedance looking into the transmitting coil with a parallel capacitor across the receiving coil is shown in equation (14).

$${Z}_{tx} = ( \frac{{ω}^{2} {M}_{12}^{2} ( \frac{R}{1 + {ω}^{2} {C}^{2} {R}^{2}} )}{{( \frac{R}{1 + {ω}^{2} {C}^{2} {R}^{2}} )}^{2} + {( ω {M}_{22} - \frac{ω {CR}^{2}}{1 + {ω}^{2} {C}^{2} {R}^{2}} )}^{2}} ) + j ( ω {M}_{11} - \frac{{ω}^{2} {M}_{12}^{2} ( ω {M}_{22} \frac{ω {CR}^{2}}{1 + {ω}^{2} {C}^{2} {R}^{2}} )}{{( \frac{R}{1 + {ω}^{2} {C}^{2} {R}^{2}} )}^{2} + {( ω {M}_{22} - \frac{ω {CR}^{2}}{1 + {ω}^{2} {C}^{2} {R}^{2}} )}^{2}} ) \qquad ( 14 )$$

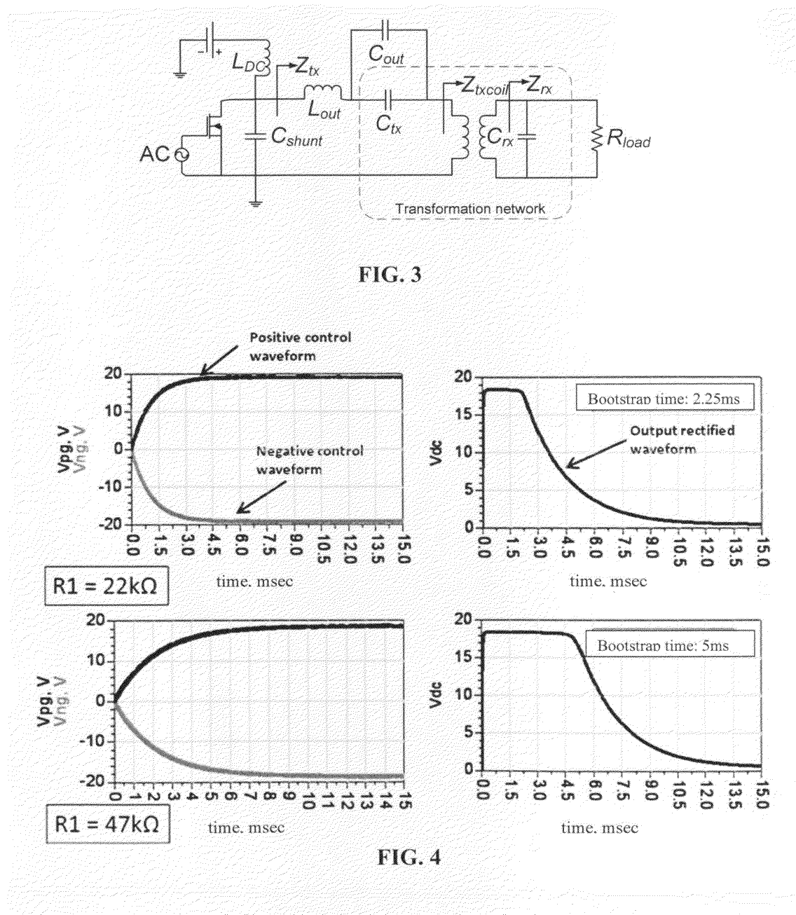

For the transmitter transformation network, a series or parallel topology can be used. Instead of selecting a parallel topology in [6], a series topology is selected to reduce component count. The Cₜₓ as shown in FIG. 3 can be integrated into Cₒᵤₜ as a single capacitor. However, to maintain an ideal efficiency above 95%, the allowable variation of load resistance of an ideal class E amplifier should be kept within +55% and −37% [23]. Therefore, an appropriate receiver capacitance value should be selected so that the resistance looking into the transmitting coil is kept within a reasonable bound but not too small to impact on the coupling efficiency. A suitable series transmitting capacitor is then needed to translate the reactance looking into the transmitting coil so that the transmitter does not suffer immediate failure when there is no receiving coil, and to produce an increasing reactance trend with increasing load resistance so as to ensure the preferred power delivery trend. Based on the above analysis, a series-parallel topology can be utilized for a specific embodiment of the subject system.

FIG. 3 shows a switched-mode Class E transmitter. Z_{tX} is the Impedance looking into the transmitter load network. Z_{txcoil} is the Impedance looking into the transmitting coil. Zᵣₓ is the Impedance looking into receiver network. R_{Load} is the equivalent resistance looking into the rectifier. In a specific embodiment, a switched-mode Class E transmitter can be preferred over the popular class D transmitter due to its simplicity and high efficiency operation. The receiver in FIG. 3 can be a single receiver or a single receiver equivalent of multiple receivers. Although, it is known that Class E operation requires its switching transistor to have a 3.562 times higher breakdown voltage than that of the Class D, it is often overlooked that the output power of an optimized ideal single-ended Class E transmitter as shown in equation (15) is 2.847 times higher than that of typical optimized ideal Class D transmitter as shown in equation (16).

$$\begin{matrix}\begin{matrix}{P}_{out - ClassE} = \frac{8}{{π}^{2} + 4} \frac{{V}_{CC}^{2}}{R} \\ = 0.5768 ( \frac{{V}_{CC}^{2}}{R} )\end{matrix} & ( 15 ) \\ \begin{matrix}{P}_{out - ClassD} = \frac{2}{{π}^{2}} \frac{{V}_{CC}^{2}}{R} \\ = 0.2026 ( \frac{{V}_{CC}^{2}}{R} )\end{matrix} & ( 16 )\end{matrix}$$

From equation (15) and (16) we can conclude that in order to achieve similar output power, the Class D requires a supply voltage that is 1.687 times higher than that of Class E. When supply voltage is constrained, a Class E transmitter can be preferred to a class D transmitter because of higher output power at the same supply voltage.

Embodiments of the invention can incorporate a receiver switch to “decouple” the receiver when certain conditions are met, such as when a receiver batter is fully charged. As the receiver can be a portable device such as cellular phone or an mp 3 player, the receiver switch used to “decouple” the receiver can preferably be compact and be able to be driven by a low voltage signal. In a specific embodiment, a voltage of not more than 3V can be used. Although, most electromechanical switches are able to tolerate large voltages and currents, they are typically large and generate a “clicking” sound during switching, which can be undesirable. Off the self solid state switches are typically designed for 50/60 Hz AC line application, and are relatively larger in size and do not offer sufficient isolation for hundreds of kilohertz signals. It is possible to find switches that operate at high frequencies but the power handling starts to drop with increase in frequency as shown in [20] unless novel materials are used as shown in [21], which tend to make the switch expensive. In addition, it is difficult to control the switch with voltages lower than the voltage being switched using a simple transmission gate topology or switch transistors. In an embodiment directed to a loosely coupled wireless power system via magnetic induction a switch architecture can be utilized that incorporates a transmission gate switch.

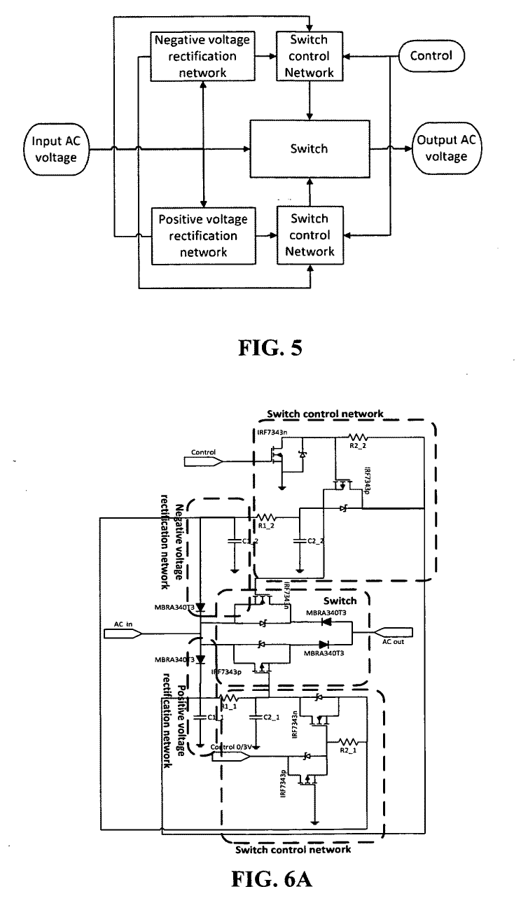

A block diagram of an embodiment of a switch architecture is shown in FIG. 5. In an embodiment, the subject switch should preferably be able to handle voltages up 25 Vrms and current up to 2 Arms, with an operating frequency up to 1 MHz. In an embodiment, the switch design can be implemented without the use of any inductors, so that the switch can be easily integrated into an IC or single package solution with the voltage regulator.

FIG. 5 shows a block diagram of an embodiment of a switch in accordance with the subject invention. The switch block shown in FIG. 5 uses a typical transmission gate architecture, which is a NMOS transistor and a PMOS transistor in parallel. A schottky diode can be added either before or after one or both transistors to counter the effect of the body diode of the power MOSFET. The schottky diode selected preferably has power handling comparable to the body diode of the transistor. The control signals to the gate of both of the transistors are provided via their respective switch control network. A rectification circuit extracts the maximum voltage and minimum voltage of the input AC voltage. The maximum voltage and minimum voltage is used as an input for the respective switch control network in a cross-coupled topology. Based on one or more control signals provided by the receiver, the switch control network will switch between the maximum voltage and the minimum voltage to either turn the transmission gate on or off.

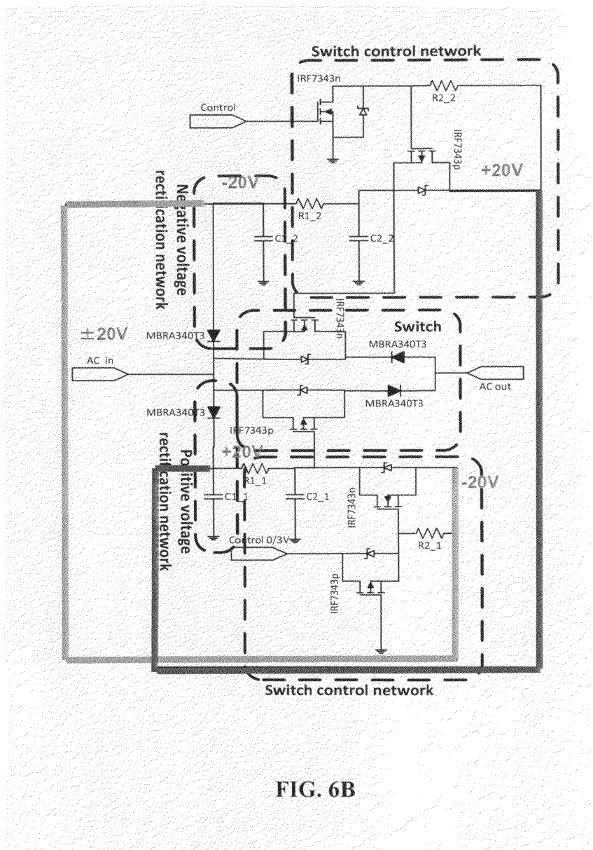

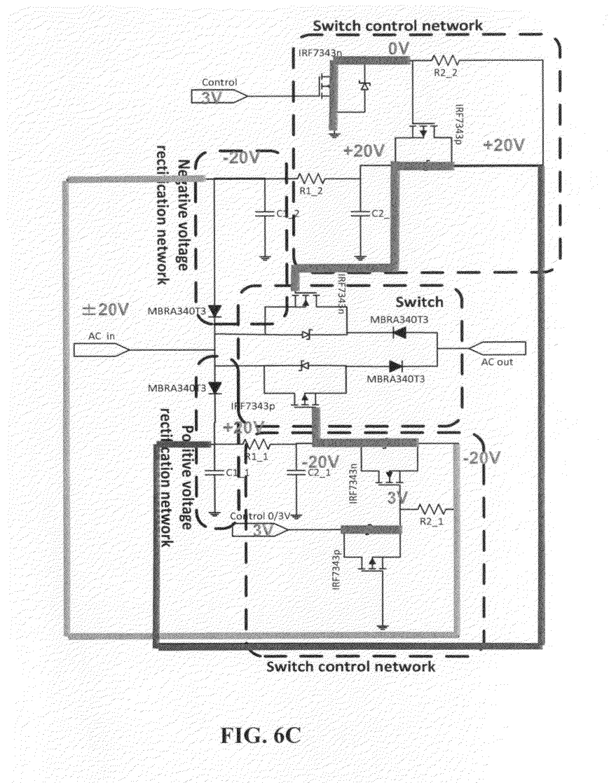

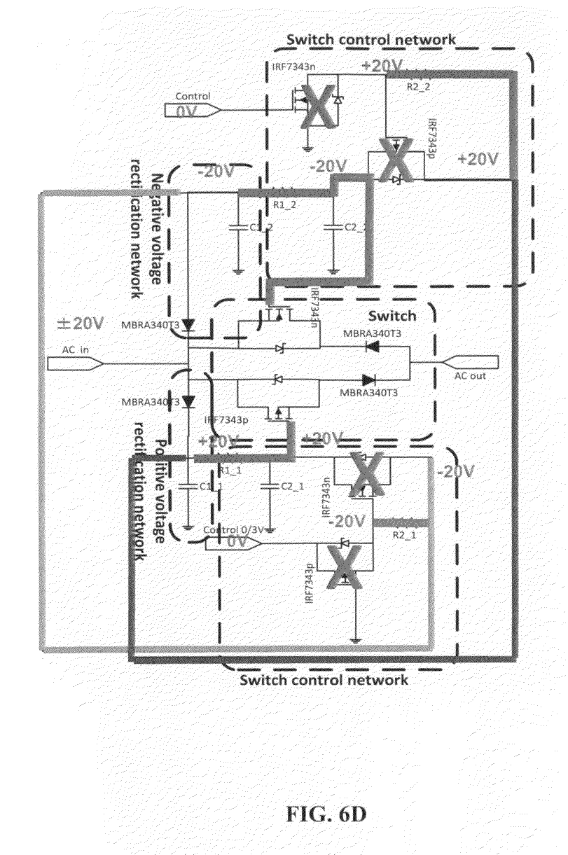

A schematic of an embodiment of the subject switch circuit is shown in FIG. 6A. A single package dual N and P channel MOSFET (IRF7343) from International Rectifier is used. The transistors have an absolute V_{gs} of 20V and an absolute V_{ds} of 55V. The peak continuous drain current of the N channel MOSFET is 4.7 A and P channel MOSFET is 3.4 A. Turn on resistance for both transistors are typically better than 0.1ω. Therefore, the transistors are able to handle considerable amount of power. Rise time and fall time of both transistors are better than 22 nS, giving it a fast response time. The input capacitor of both transistors is typically less than 750 pF, which allows easy driving of the transistor. The C_{gd} of both transistors are less than 100 pF and C_{ds} of both transistor are less than 125 pF, reducing the leakage current at high frequency when the switch is turned off. MBRA340T3 is selected for both the rectification network diode and switch. This is because MERA340T3 is able to handle voltages up to 40V and currents up to 3 A. In addition, it is has a small forward voltage drop of 0.45V and being a schottky diode it has negligible reverse recovery time.

Notation for resistors and capacitors are in the form of RX_X and CX_X. The number after the underscore is used to differentiate between the two switch control networks, which are similar. Namely channel 1 for the P channel MOSFET of the transmission gate and channel 2 for the N channel MOSFET of the transmission gate. Value for C1 is 100 nF, C2 is 10 nF, R1 is 10 kΩ and R2 is 47 kΩ.

FIG. 6B shows how the +20V rectified positive voltage signal and the −20V rectified negative voltage signal are supplied to the switch control networks. FIG. 6C shows how, in the specific embodiment of FIG. 6A, when a 3V control signal is provided to the switch control networks, a +20V rectified positive voltage signal is supplied to the gate of the NMOS transistor of the transmission gate and a −20V rectified negative voltage is supplied to the gate of the PMOS transistor of the transmission gate. FIG. 6D shows how, in the specific embodiment of FIG. 6A, when a 0V control signal is provided to the switch control networks, a −20V rectified negative voltage signal is supplied to the gate of the NMOS transistor of the transmission gate and a +20V rectified positive voltage signal is supplied to the gate of the PMOS transistor of the transmission gate. In alternative embodiments, the control signals to the switch control networks can be different. As an example, a 0V signal can be supplied to one switch control network when a 3V signal is supplied to the other. In such an embodiment, the switch control networks can be identical. Further, different values can be used as control signals, such as 5V. In alternative embodiments, a single switch control network that outputs two signals and receives one or two, or more, control singles, in addition to the rectified positive signal and the rectified negative signal.

The control single(s) can be provided by circuitry that monitors the variable load, where the variable load can included one or more batteries and/or other circuitry requiring power.

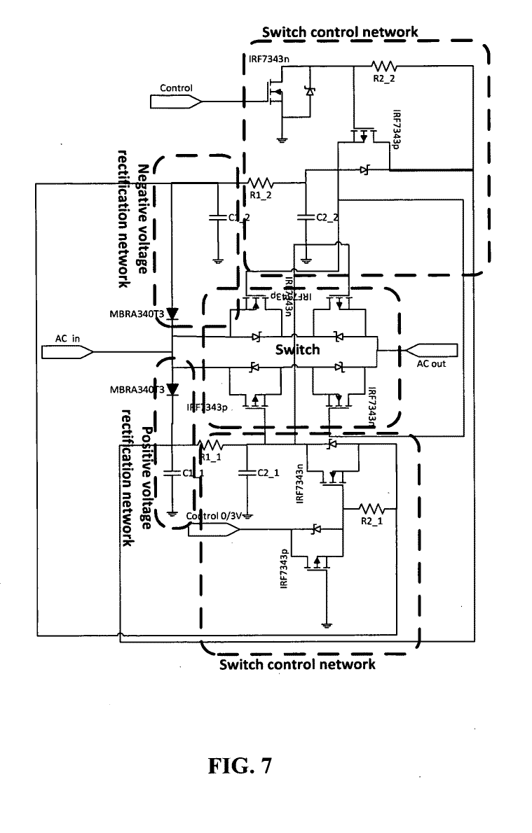

In a further embodiment of the switch, the diode in series with the transmission gate transistors can be replaced with a transistor, as shown in FIG. 7. By doing so, the power signal will not suffer a forward voltage diode drop, reducing the losses through the switch. However, the switch control network should preferably ensure that it is able to drive the extra gate loading the two rectification networks. In an embodiment, since the diodes used have quite a low forward drop voltage, and for simplicity, the switch can use the schematic of FIG. 6A.

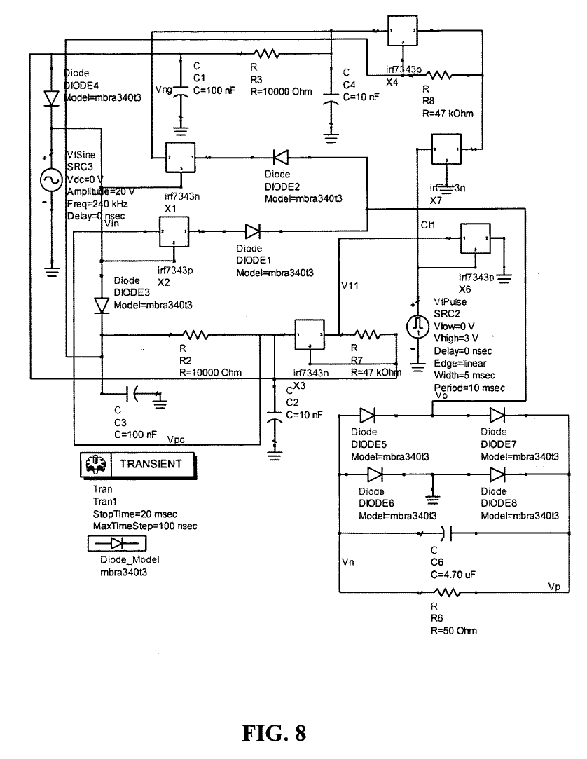

Simulation and verification of the switch can be performed using Advanced System Design. The simulation schematic to analyze the performance of the switch with a loaded full wave rectifier as load is shown in FIG. 8. The DC load is set to 50Ω. Transistor and diode model in the simulation are obtained from the manufacturer. Therefore, the simulation results should match the performance of the fabricated circuit.

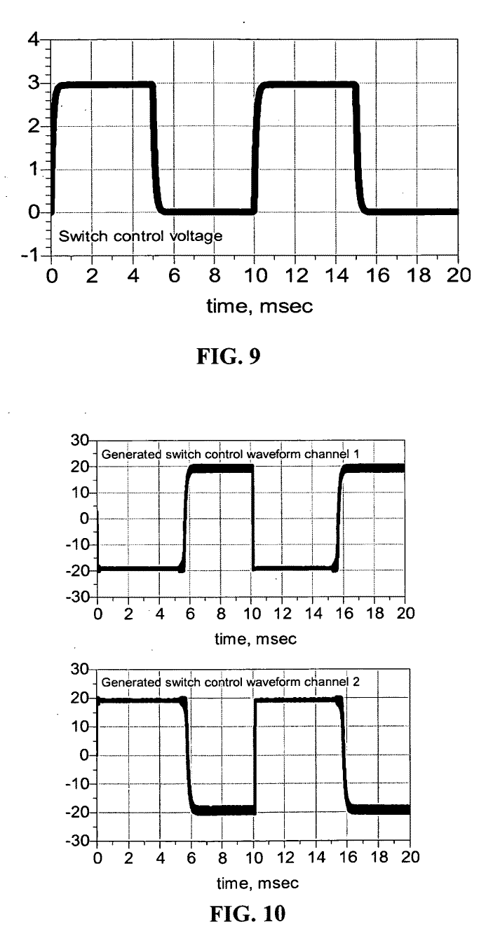

FIG. 9 shows a switch control waveform, which is 0V for off state and 3V for on state, at a 50% duty cycle and a frequency of 100 Hz. Based on the transistor used (IRF7343), the switch is able to operate at turn on voltages as low as 1V. FIG. 10 shows a generated switch control voltage for each respective channel. The turn off response time for channel 1 is approximately 630 μS and turn off response time for channel 2 is approximately 700 μS. The turn on response time for channel 1 is approximately 60 μS and turn on response time for channel 2 is approximately 70 μS. Therefore, the switch can safely operate up to 1 kHz switching frequency. The turn on time is significantly faster than the turn off time because the voltage across the C1 and C2 are the same when the switch is turned off and when the switch transits from the off stage to on stage C2 is charged/discharged via the low resistance path through the transistor whereas when the switch transits from the on stage to the off stage C2 is charged/discharged via resistor R1, which increases the time constant significantly. Response time can be improved by decreasing R1 at the expense of power loss through the switch. Decreasing either C1 or C2 also helps to improve the response time. However, the ripples on the rectified voltage might get too significant and affect the operation of the circuit.

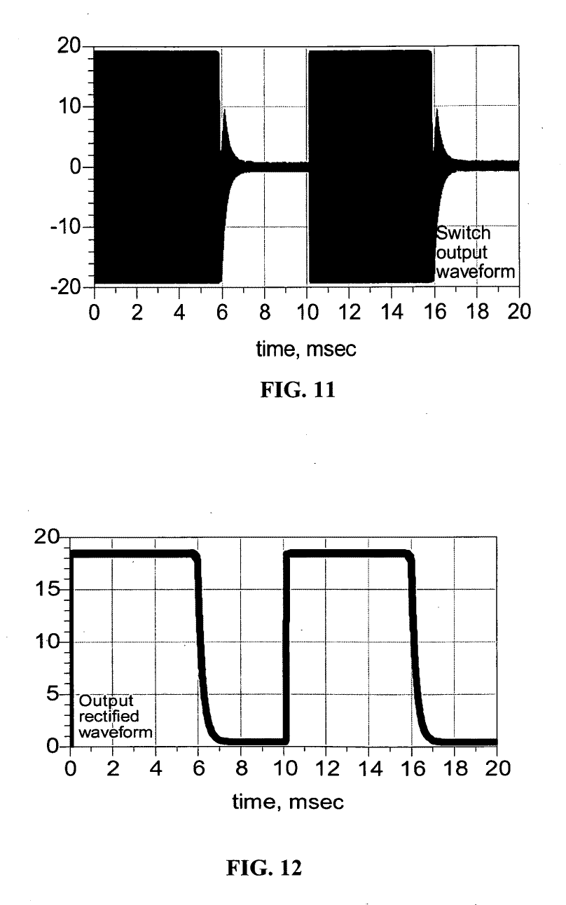

FIG. 11 shows the output AC waveform of the switch before the rectifier and FIG. 12 shows the rectified waveform. The fall time of the rectified waveform is dependent on the capacitance value of the smoothing capacitor. If the smoothing capacitor is too big it will take a considerable amount of time for the rectified waveform to drop to 0V. If the smoothing capacitor is too small the ripples on the DC voltage will be more significant. The smoothing capacitor is selected to be 4.7 μF.

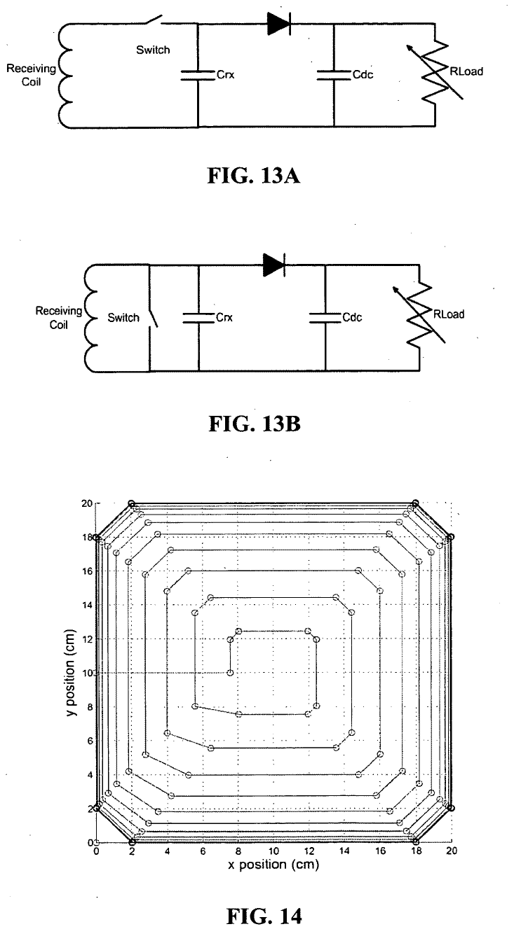

FIG. 13A shows an embodiment of a receiver architecture, which can incorporate a switch in accordance with the subject invention. In a specific embodiment, the switch of FIG. 6A or FIG. 7 can be used. In this way, when the switch is open, little or no power flows to the load, and when the switch is closed, power flows to the load.

FIG. 13B shows an embodiment of a receiver architecture, which can incorporate a switch in accordance with the subject invention. In this embodiment, when the switch is closed, power circulates through the receiving coil and does not flow to the load, and when the switch is open, power flows to the load. In this embodiment, a half wave rectifier is used instead of a full wave rectifier because the circuit will be more compact using a single diode instead of four. In alternative embodiments, a full wave rectifier can be used. Another benefit is that the rectification process only suffers a single diode forward voltage drop instead of two. In addition, the operating frequency will be in the range of hundreds of kilohertz, thus the receiver architecture will not require a very large charge holding capacitor. Instead of using the switch in the power path, the switch can be placed shunt across the coil. There are two reasons in using such a topology. First, by shorting the receiving coil, the receiver coil sees a short. Therefore, Rᵣₓ and Xᵣₓ in equation (6) will be extremely small, such that they can be assumed to be zero. Let Xᵣₓ in equation (6) be zero.

$${Z}_{tx} = \frac{{ω}^{2} {M}_{12}^{2} {R}_{rx}}{{R}_{rx}^{2} + {( ω {M}_{22} )}^{2}} + j ( ω {M}_{11} - \frac{{ω}^{3} {M}_{12}^{2} {M}_{22}}{{R}_{rx}^{2} + {( ω {M}_{22} )}^{2}} ) \qquad ( 17 )$$

Next let Rᵣₓ in equation (17) to be zero.

$${Z}_{tx} = j ( ω {M}_{11} - \frac{ω {M}_{12}^{2}}{{M}_{22}} ) \qquad ( 18 )$$

Substituting equation (3) into equation (18)

Zₜₓ=j(ωM₁₁−ωk²M₁₁) (19)

In order for the system to be able to support multiple devices and provide sufficient lateral freedom, it is reasonable for the coupling coefficient to be much less than 0.25. By assuming that the coupling coefficient to be 0.25, k² will be 0.0625, which is much lower than 1. Therefore, if the receiving coils are shorted under loose coupling condition, the transmitter only sees the self inductance of the transmitting coil.

The second reason is that the switch's natural state is in its open state when no voltage is applied to the control port. Therefore, the receiver will allow power to pass through when the control port is left float. This can be important, especially when the battery on the receiver is full drained and is unable to control the switch. By using the architecture shown in FIG. 13B, the receiver does not require any bootstrapping, even when there is no power on the receiver, to turn the receiver on because it will be in a naturally on state.

Embodiments of the subject wireless power system can be designed by setting constraints of the dimensions of the transmitting and receiving coil, as well as operating frequency. Although, higher operating frequency is preferred to shrink the components, switching and parasitic losses can become high. A specific embodiment can operate at an operating frequency of 240 kHz. Other embodiments can operate at higher or lower frequencies. Specific embodiments can operate in one of the following ranges: 50 kHz-500 kHz, 1 Hz-1 MHz, 1Hz-10 MHz, and 1 Hz-1 GHz. For simplicity of analysis, the load resistance can be defined as the equivalent resistance looking into the rectifier instead of after the rectifier. It is desirable for the receiving coil to be much smaller than the transmitting coil, but efficiency and power transfer capabilities start to degrade significantly due to poor coupling if the receiver is too small. Accordingly, it is preferred to keep the coupling coefficient k above 0.1. To minimize space usage as well as ease of integration into the target device, the receiving coil is typically tightly wound. However, the windings of the transmitting coil are very different from the receiving coil. The gaps between each turn of the transmitting coil can be spaced in a manner to achieve even field distribution and consistent performance regardless of the placement of receiving coil.

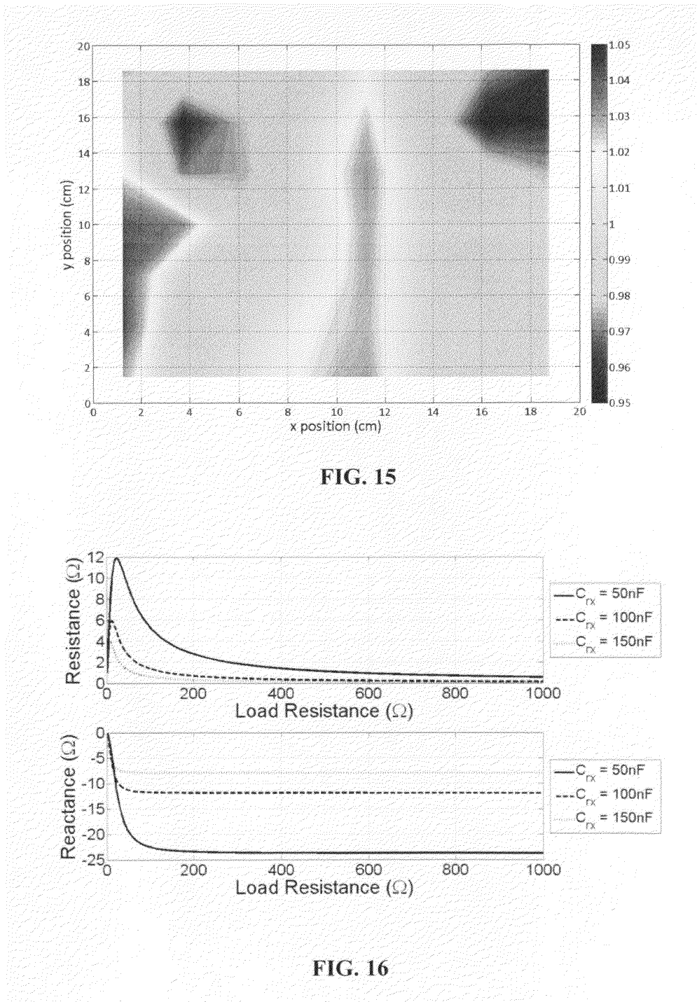

FIG. 14 shows the windings of a 13 turns 20 cm×20 cm transmitting coil that can be used in an embodiment, and that is used for the Example. The last 3 turns of the windings are so close that they overlapped each other. Other designs for the transmitting coil windings can be used and preferably achieve an even magnetic field distribution. The normalized power delivery with respect to the location of the transmitting coil in FIG. 14, using a tightly wounded receiving coil of 9 cm×6 cm, is shown in FIG. 15. The receiver is 13.5% of the size of the transmitter. Power delivery variation is kept within ±5% and the standard deviation of power delivery is only 2.2%. Based on the observed distribution of power delivery with respect to receiver location, it can be assumed that the generated magnetic field is even and the variations are due to measurement errors.

Key parameters of the coils, including self inductances, mutual inductance, and parasitic resistances, can be extracted by measuring the fabricated coil with an impedance analyzer or analyzing with electromagnetic simulation tools. The coils were fabricated using 100/40 round served Litz wires for the experiment to mitigate proximity effect and skin effect. The 100/40 round served Litz wires have 100 strands of 40 gauge wires insulated from each other. The self inductance of the transmitting coil is 45.3 μH with a parasitic resistance of 0.5Ω. The self inductance of the receiving coil is 5.2 μH with a parasitic resistance of 0.1Ω. Mutual inductance between the coils is 2.8 μH with a coupling coefficient of 0.1824. Both of the coils were measured using the HP4192A LF Impedance Analyzer.

The design of the system, including the determination of Cᵣₓ value, can start from the receiver looking into the load. The typical impedance response for different parallel capacitors is shown in FIG. 16. The capacitance value is selected based on the inductance of the receiving coil as well as the mutual inductance between the coils. Although, it will be desirable to achieve a maximum resistance looking into the transmitting coil across a wide range of load resistances [6], the resistance variation looking into the transmitting coil might be too big, thus requiring a shunt capacitor across the transmitting coil to “compress” the resistance resulting in the parallel-parallel impedance transformation network topology. Therefore, it will be more practical to select a capacitor value that will generate the desirable resistance range looking into the transmitter load network Zₜₓ, shifting of the reactance value to achieve a desirable phase response so as to achieve a desirable power delivery profile can be done by varying Cₒᵤₜ or Lₒᵤₜ. In order to determine the range of resistance looking into the transmitting coil an appropriate Lₒᵤₜ value can be selected first.

The class E transmitter requires a minimum loaded Q of 1.7879 to operate [22]. There are two factors that affect the decision of Lₒᵤₜ. For the same loaded Q value it is desirable to have Lₒᵤₜ as large as possible so that the resistance looking into the transmitting coil will be larger. Therefore, the parasitic resistance of the transmitting coil can be neglected. However, if Lₒᵤₜ is too large the parasitic resistance of the inductor will be relatively large unless a better inductor of lower parasitic resistance is used. However, when the parasitic resistance of the inductor of the same inductance value gets lower the size of the inductor also gets bigger. The lowest loss inductor will be an air core inductor using Litz wire but it will be a lot bigger in size. In addition, based on equation (15) if the resistance looking into the transmitting coil is too large limited power will be delivered to the receiver. On the other hand if Lₒᵤₜ is too small the maximum value of the resistance looking into the transmitting coil will be limited. Therefore, with a small resistance looking into the transmitting coil the parasitic resistance of Lₒᵤₜ and the transmitting coil will get more significant affecting the system efficiency and power delivery.

For an operating frequency of 240 kHz the system can operate well with a Lₒᵤₜ value from 6.8 μH to 22 μH depending on the parasitic resistance of the transmitting coil, the parasitic resistance of Lₒᵤₜ and Cₒᵤₜ as well as size constrain. For this design, a 10 μH inductor (RL-5480-5-10 from Renco) is selected. The inductor has low loss, 0.16Ω of parasitic resistance at 240 kHz and is considerable small in size (15.875 mm diameter and 17.78 mm height). However, the effective inductance of the inductor is 9.5 μH instead of 10 μH at 240 kHz. The inductance will further decrease with higher current and temperature.

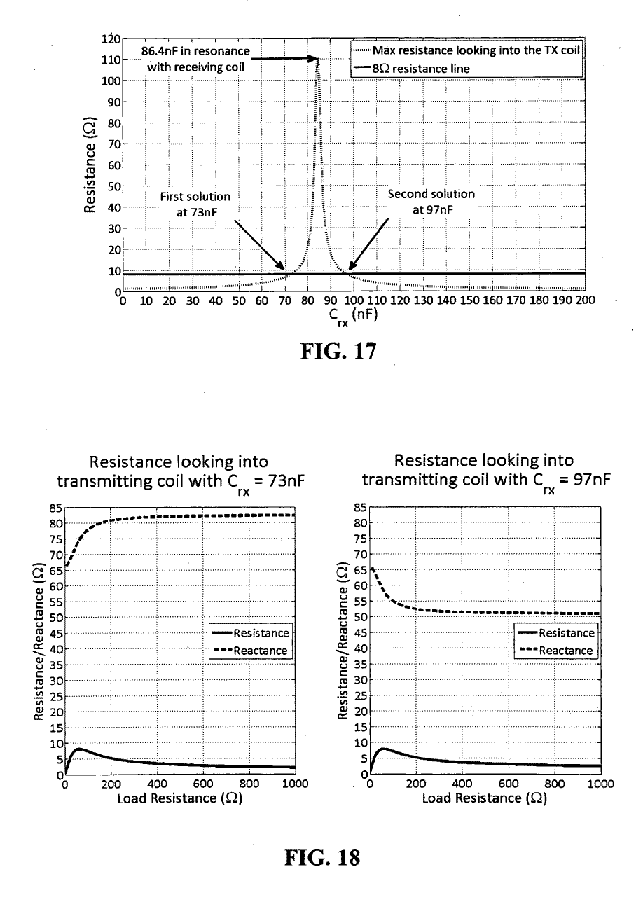

Based on the minimum loaded Q from [22], the resistance looking into the transmitting coil should not larger than 8Ω. Therefore, by performing a sweep on the receiver capacitor from 0.1 nF to 200 nF as shown in FIG. 17 illustrates that there are two possible solution, 73 nF and 97 nF. It can also be seen from FIG. 17 that the peak resistance occurs at a Cᵣₓ value of 86.4 nF, which will cause the capacitor to be in resonance with the receiving coil. Although such an operating point is desirable to give maximum resistance looking into transmitting coil, the class E amplifier has limited operating load resistance range. Therefore, a bounded resistance range is more desirable in this case.

Although both receiver capacitance values provide the same resistance trend looking into the transmitting coil, the reactance trend is different. Using a capacitance value of 73 nF before the resonance capacitance value of 86.4 nF results an increasing trend of reactance with increasing load resistance converging at approximate 82Ω. On the other hand, a capacitance value of 97 nF will result in a decreasing trend of reactance with increasing load resistance converging at approximately 51Ω. According to equation (20), increasing the reactance while keeping the resistance relatively the same will decrease the power delivery. Therefore, in order to obtain the desirable trend of decreasing power delivery with respect to increase load resistance the first solution of 73 nF before the resonance capacitor value with the receiving coil can be selected.

$$\begin{matrix}P = \frac{{V}^{2}}{{Z}_{tx}} cos θ \\ = \frac{{V}^{2} {R}_{tx}}{{Z}_{tx}^{2}}\end{matrix} \qquad ( 20 )$$

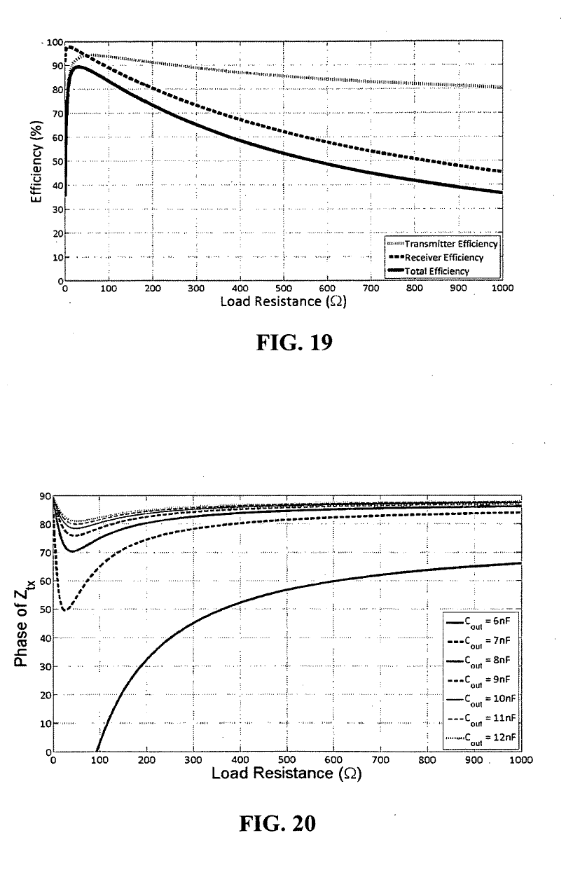

Based on the selected receiver capacitance value, the efficiency of the coupling with respect to load resistance as shown in FIG. 19 can be calculated using the parasitic resistance of the coil. Coupling efficiency peaks at close to 90% at a load resistance of 30Ω. Although efficiency rolls off to an approximate 36% at 1 kΩ, power delivered at the resistance is extremely low. The gradual degradation in receiver efficiency is desirable as it helps to regulate the power during trickle charge. Power delivered by the transmitter remains consistent at high load resistances because the equivalent load impedance Z_{tX} looking into the transmitter load network does not change much.

FIG. 20 shows the phase response of Zₜₓ with respect to load for different Cₒᵤₜ values. High efficiency is achieved at a range of phase angle from 40° to 70° [21]. Therefore, in accordance with an embodiment, any value above 7 nF can be used for Cₒᵤₜ. Since the coil inductance is large, the phase response will be sensitive to the component values and a large phase response swing can be observed in FIG. 20 when Cₒᵤₜ is changed from 6 nF to 7 nF, Cₒᵤₜ should be selected to achieve maximum power delivery and stability, thus Cₒᵤₜ is selected to be 8 nF. However, a higher Cₒᵤₜ can be selected to limit the power delivery as shown in equation (20).

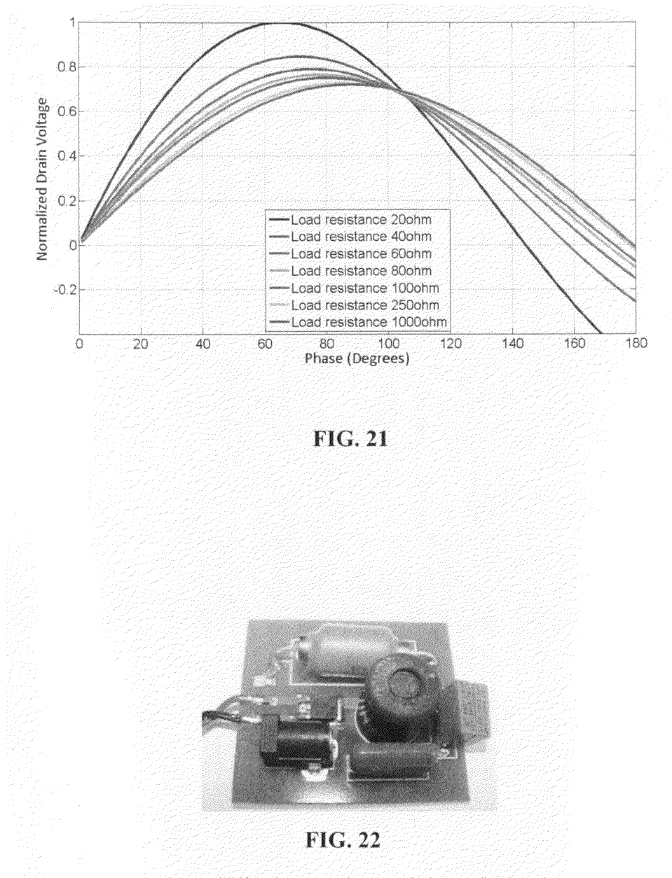

Once the values of the inductors and capacitors in the transmitter load network and the receiver network are determined, the remaining step is to determine Cₛₕᵤₙₜ to achieve ZVS and ZDS operation so as to minimize switching losses. The optimum Cₛₕᵤₙₜ value can be determined using the equations derived in [23]-[24] and implemented in Matlab code. The optimum Cₛₕᵤₙₜ is found to be 10 nF and the variation of transistor drain voltage versus load resistance is shown in FIG. 21. It can be seen that the transistor drain voltages are kept very close to zero when the transistor is being switched on at a phase of 180°. In addition, the negative voltages do not occur because the built in diode will start to conduct and restrict the voltage at the negative of its turn on voltage which is around −1.3V.

### EXAMPLE 1

### A Class E Transmitter System

A Class E transmitter system using the IRLR/U3410 HEXFET® power MOSFET rated at 100V breakdown voltage from International Rectifier. A half wave rectifier with a shunt charge holding capacitor of 4.7 μF at the output using MBRA340T3 from ON Semiconductor is used to convert the AC power to DC power. Since the forward voltage drop is 0.45V and the reverse recovery is negligible, power loss due to the voltage drop and reverse recovery is small compared to the amount of power delivered to the load. Load resistance in this section can be assumed to be the equivalent resistance looking into the regulator or device being charged or powered as shown in FIG. 1 instead of the equivalent resistance looking into the rectifier as shown in FIG. 3.

A Matlab code is written based on the equations derived in [19]-[20] to study the power delivery. Instead of using the calculated value, the value used for the power delivery simulation can be actual values used for the verification in this example. This is done to enable an accurate comparison between the simulated results and the measured results. All analysis and simulation results are based on a 12V power supply. The 12V power supply is selected because the supply voltage can be obtained directly from a car's DC supply plug and any other AC-DC converter. Power delivery can be increased by increasing the supply voltage or vice versa. This assumption is always true as long as the drain voltage is below the breakdown voltage of the transistor used.

Table I shows the calculated value of each component with respect to the actual component value used in the setup for this example. The calculated values are initially used and further tuned using the fabricated setup to achieve optimum power delivery and efficiency across a wide range of load resistance. Cᵣₓ is selected to be 75 nF. Since the switch contributes 3.5 nF of capacitance and the rectifier contributes another 3.5 nF of capacitor, a 68 nF capacitor is used to achieve an effective capacitance of 75 nF which is quite close to 73 nF. Capacitance contributed to the receiver due to the switch and rectifier is measured using the HP4192A LF Impedance Analyzer not during active operation. Therefore, the actual capacitance contributed can be slightly different depending on the load conditions and voltage at the switch and rectifier. Cₒᵤₜ is slightly larger than the calculated value to regulate the power delivery, as the target device can be a USB powered device drawing 500 mA at 5V. A Cₒᵤₜ value of 9.4 nF was selected by placing two 4.7 nF capacitors in parallel. In order to reduce losses through parasitic resistance, low loss polypropylene capacitors are used. The Cₛₕᵤₙₜ value is larger than the calculated value because Cₒᵤₜ is increased from 8 nF to 9.4 nF. In addition, the equation used in [20] assumes the transistor to be an ideal switch. Therefore, while calculating the drain voltage, the body diode in the transistor and other parameters such as turn on resistance were not taken into account. The other parameters of the transistor do not have any significant effect on the calculated values since the rise and fall times of the transistor are significantly faster than the switching time and the drain-to-source capacitance is less than 1 nF.

TABLE I
COMPONENT VALUES

| | Calculated | Experimental | % Variation |
|---|---|---|---|
| Cᵣₓ | 73 nF | 75 nF | +2.7% |
| Cₒᵤₜ | 8 nF | 9.4 nF | +17.5% |
| Lₒᵤₜ | 9.5 μH | 9.5 μH | 0% |
| Lₒᵤₜ parasitic | — | 0.16 Ω | — |
| resistance | | | |
| Cₛₕᵤₙₜ | 10 nF | 12 nF | +20% |
| TX coil inductance | — | 45.3 μH | — |
| TX coil dimension | — | 20 cm × 20 cm | — |
| TX coil parasitic | — | 0.5 Ω | — |
| resistance | | | |
| RX coil Inductance | — | 5.2 μH | — |
| RX coil dimension | — | 9 cm × 6 cm | |
| RX coil parasitic | — | 0.1 Ω | — |
| resistance | | | |
| Mutual Inductance | — | 2.8 μH | — |
| L_{DC} | — | 500 μH | — |

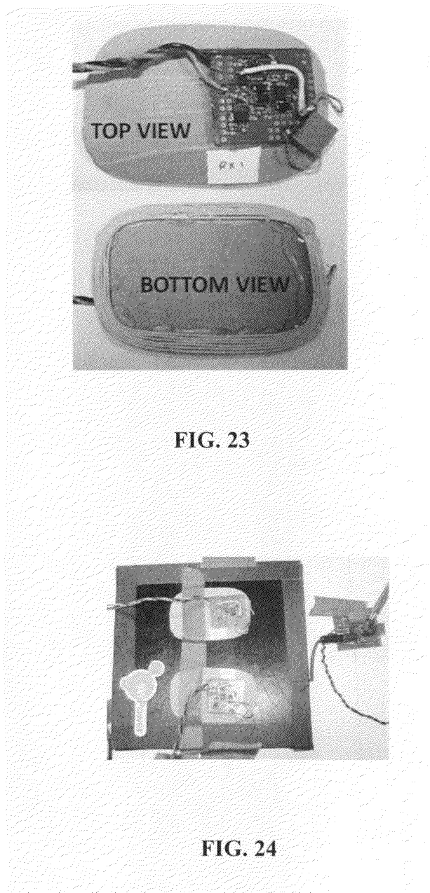

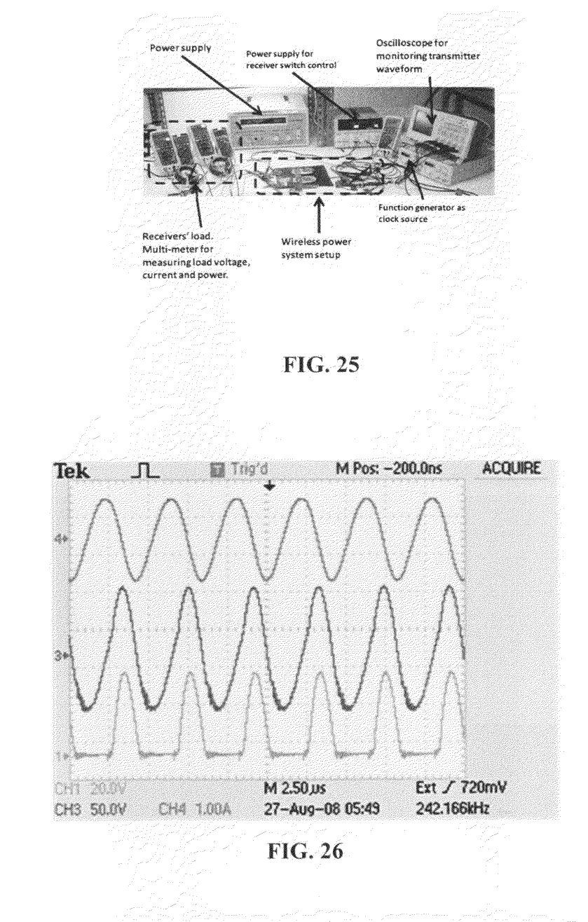

The fabricated transmitter with a dimension of 5 cm×5 cm is shown in FIG. 22. The clock of the circuit is fed into the PCB via the blue and black view for which the black wire is the ground. The jack is used to connect the transmitter to the transmitting coil. The tallest component is the black 10 μH inductor standing at 17.78 mm. The components on the PCB is well spaced out and can be made more compact (board size should be able to be shrink by 30%). FIG. 23 shows the top view and bottom view of the receiver. The receiver PCB is 3.5 cm by 3.5 cm. The blue capacitor is the 68 nF low loss polypropylene capacitor. The output DC voltage is connected to a load resistance via the orange and black wire for which the black wire is the ground. Control signal to turn on and off the switch is via the blue and black wire for which the black wire is also the ground. The yellow wire is used to route the power signal at the receiving coil to the rectifier. FIG. 24 shows the photograph of a setup with two receivers on the packaged transmitting coil. The actual spacing between the transmitting coil and receiving coils is the thickness of the transmitting coil packaging material which is approximately 2 mm. The receivers are taped onto the transmitting coil to ensure all the measurements are consistent. The full test bench used to conduct the experiment is shown in FIG. 25.

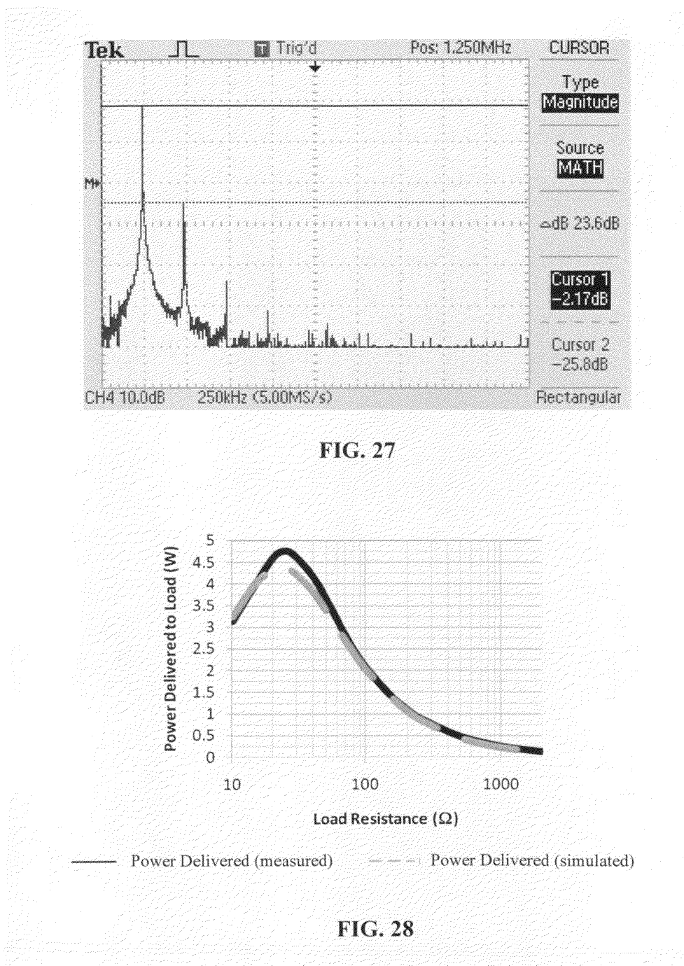

FIG. 26 shows the waveform of the transmitter drain voltage as channel one, transmitter coil voltage as channel three and transmitter coil current at channel four measured using TDS2004B from Tektronix while delivering power to a single receiver with a load resistance of 50Ω. Although the duty cycle of the drain voltage is slightly less than 50%, ZVS operation is achieved due to the transistor's body diode. The maximum drain voltage is only 44.8V, which is a lot lower than the rated drain voltage of the transistor. Therefore, power delivery can be increase by increasing the supply voltage of the transmitter without damaging the transistor. The maximum coil voltage is 92V while the minimum coil voltage is −74V. The asymmetry coil voltage is due to its harmonics which were introduced by the low loss low Q circuit configuration. The maximum current is 1.04 A while the minimum coil current is −1.16 A. Since the field generated by the transmitting coil is determined by the coil current, the spectrum of the coil current needs to be analyzed. A FFT operation is done on the coil current using the oscilloscope internal Maths function to obtain the spectrum of the coil current shown in FIG. 27. The harmonics content of the transmitter's coil current is limited. The second harmonic of the coil current is 23.6 dB below the fundamental tone. The third harmonic and beyond is so weak that it can be neglected.

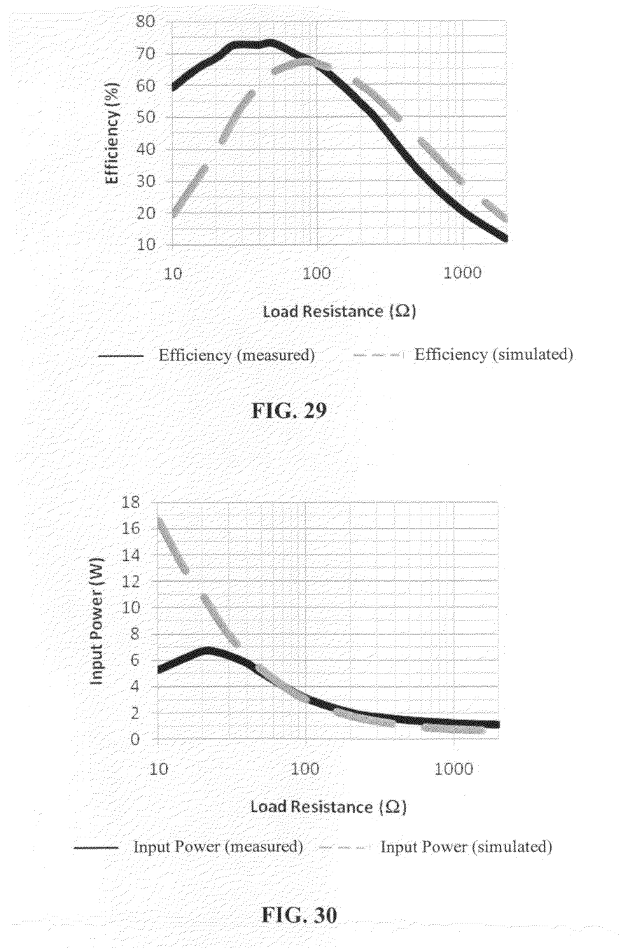

Power delivery to the receiver with respect to load resistance of a 1 to 1 setup is shown in FIG. 28. The simulation and measured trend of a single receiver setup matches relatively close with peak measured power at approximately 4.75 W. Further analysis shown later that for a system with dual receiver, the maximum power delivery will be slightly lower, thus the components selected are optimized for both single and dual receiver operation. System efficiency with respect to load resistance for a 1 to 1 setup is shown in FIG. 29. The simulated results are slightly higher for resistances higher than 100Ω because in the simulation model, the transistor and DC feed inductor are assumed to be ideal, thus the actual results tend to be lower. However, simulated efficiency at lower load resistance deviates significantly from the measure results. This is because the calculated input power is significantly larger than the measure results as show in FIG. 30. This is because the model used in [19]-[20] does not include the transistor's built-in diode effect. The discrepancy becomes greater when the zero crossing of the drain voltage gets much lesser than 180°.

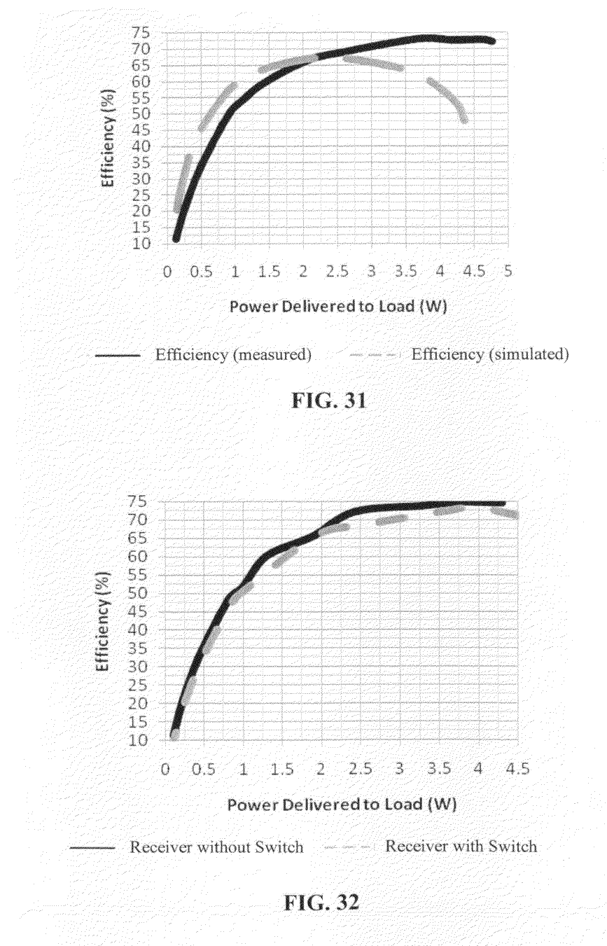

A comprehensive plot to analyze the performance of the system is shown in FIG. 31, which shows the system efficiency with respect to power delivery. From FIG. 31 one can get a good understanding of the power delivery and efficiency profile. Part of the curve for which the power delivered to the load starts to decrease after the maximum when the load resistance is very low is omitted. This is because a buck regulator will be used to regulate the unregulated receiver DC voltage to 5V and the regulator will increase its effective resistance to reduce power delivery and the unregulated voltage of the receiver will be relatively low that the buck regulator will not be its correct operating mode. Experimental verification of the system with a buck regulator is not done because the regulator with the load can be view as an effective load and selection of the regulator is application specific. It is observed that most regulators will automatically pick the operating point for which the load resistance is higher to avoid the incorrect operating mode. Therefore, the part of the curve for which the power delivery starts to loop back after the maximum power is not of interest. In addition, the system power loss can be easily deduced from FIG. 31.

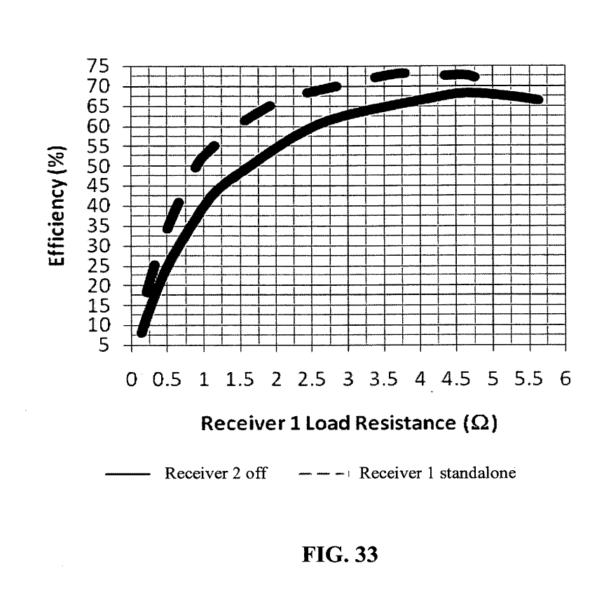

FIG. 32 compares the performance of the receiver with and without the switch in place during nominal operation with the same transmitting platform. Power delivery capabilities of both receivers are approximately the same peaking between 4.5 W to 4.75 W. It can be observed that the efficiency of the receiver with the switch is slightly lower by approximately 1 to 2%, the difference is so small that it can be neglected. The phenomena can be explained by the fact that the switch is in shunt with the receiver instead of series, thus the switch is not in the power delivery path. Therefore, the impact of the switch is minimized during receiving mode. On the other hand, power loss during the off mode is more significant than that of the on mode. FIG. 33 compares the performance of a single receiver with the switch and dual receiver setup with one of the receivers switched off. It can be seen that the efficiency degrades an average of 5% and up to 10% even though the 2^{nd} receiver is turned off. Even though the receiver is “decoupled” from the system the switch still has some turn on resistance when it attempts to short the coil. Therefore, a small amount of power is still dissipated across the switch. In addition, it can be observed that peak power delivery is increase to almost 5.75 W. By looking at equation (18), it can be seen that even though the receiver is “decoupled” from the system, the “decoupled” receiver still reduces the reactance looking into the transmitting coil slightly. If the reactance is reduced while keeping the resistance the same, the phase angle will be decreased. From equation (20) it can be seen that if the phase angle is reduced the power delivery will increase. Therefore, explaining the phenomena observed in FIG. 33.

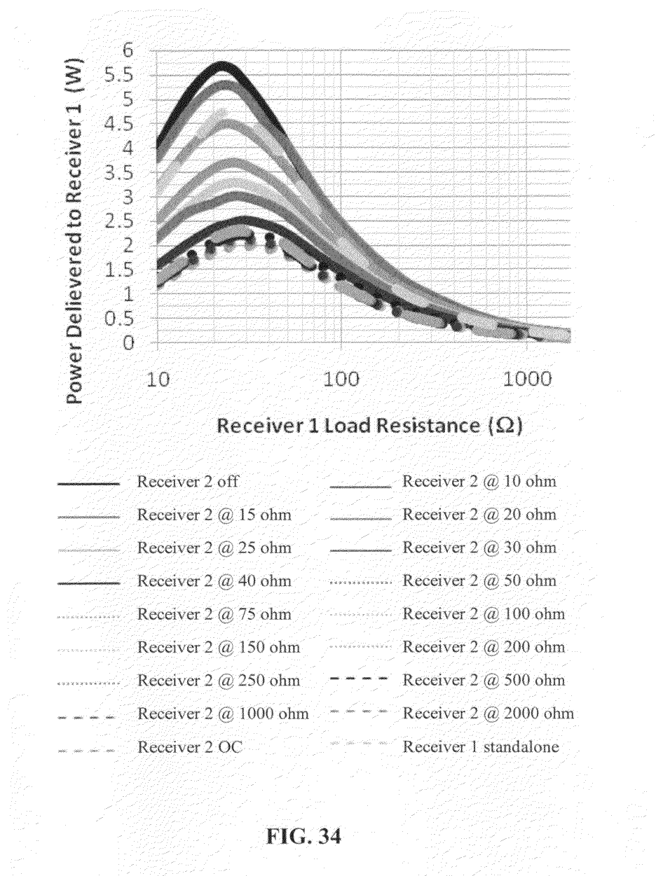

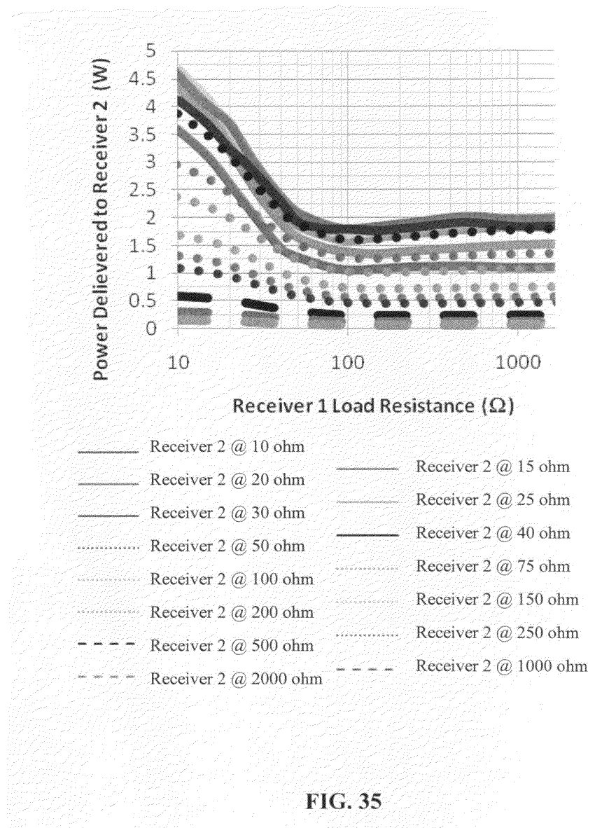

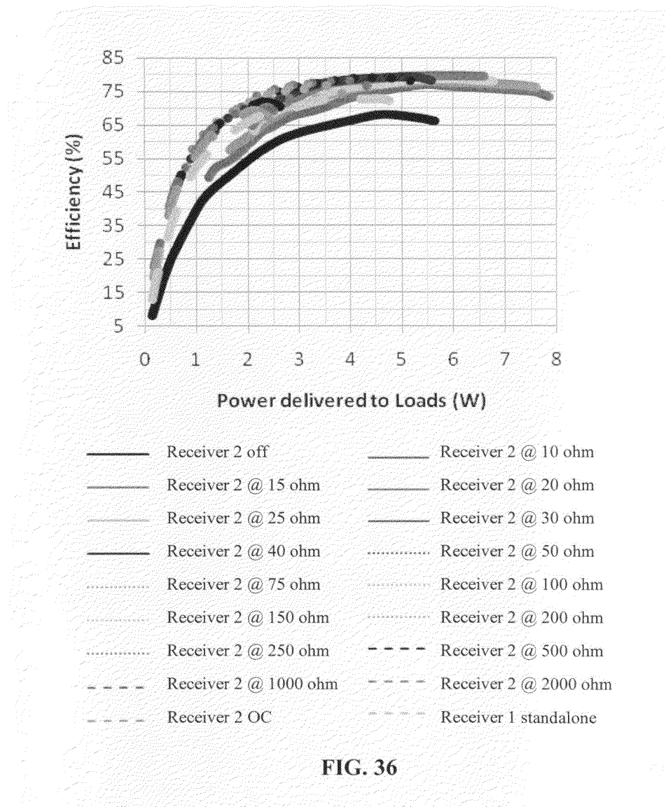

The experimental verification and analysis for two receivers has been provided. Similar trends can apply for receiver numbers larger than two. The power delivery of a dual receiver platform can be studied by holding the load resistance of one of the receivers at a fixed value while the load resistance of the other receiver is swept across the range of 10Ω to 2000Ω in 15 steps (10Ω, 15Ω, 20Ω, 25Ω, 30Ω, 40Ω, 50Ω, 75Ω, 100Ω, 150Ω, 200Ω, 250Ω, 500Ω, 1000Ω and 2000Ω). For the following experiment the load resistance of receiver 2 is held fixed at a specific value while the load resistance of receiver 1 is swept across the stated ranged. FIG. 34 shows the power delivery to the receiver 1 with its load resistance swept with respect to its load resistance while FIG. 35 shows the power delivery to receiver 2 with its load resistance fixed with respect to the load resistance of receiver 1. When the load resistance of receiver 2 is kept above 40Ω, the variation of power delivery to receiver 1 is limited with power peaking at approximately 2 W to 2.5 W. In addition, power delivery to receiver 2 also stays consistent in regardless of the load resistance or power delivery to receiver 1 as long as the load resistance of receiver I stays about 40Ω. Therefore, to reduce the dependency of the receivers on each other it will be desirable for the minimum load resistance to be not less than 40Ω. However, this will reduce the power delivery significantly.

The minimum load resistance can be designed by selecting an appropriate regulator and setting the appropriate power delivery profile by changing Cₒᵤₜ or the supply voltage. This will set the unregulated input voltage before the regulator to achieve the specified load resistance looking to the regulator while it is at its maximum power delivery. It can also be seen that once the fully charged receiver (receiver 2) is “decoupled” from the system using the embodiment of the subject switch, power delivery to the other receiver (receiver 1) increases significantly. Therefore, the switch is used to prevent the receiver that is fully charged from “choking” the other receiver of the power it needs. This can mitigate the effect of reduced charge rate for the receiving devices so that the system can deliver sufficient power to the receiver.

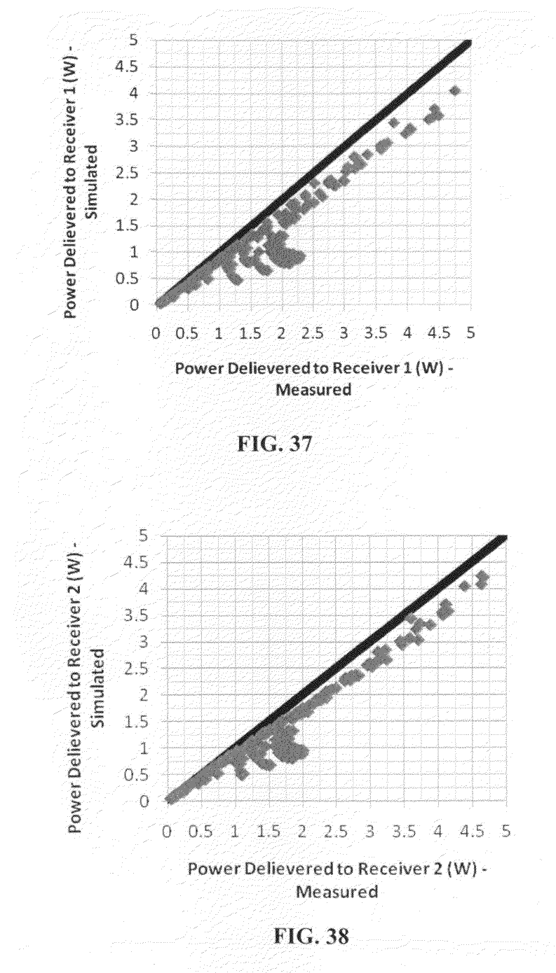

FIG. 37 shows the plot of the system efficiency with respect to total power delivered to the loads with receiver 2 fixed at a specific load while sweeping the resistance of receiver 1 from 10Ωto 2000Ω. End to end, DC to unregulated DC system efficiency is kept above 50% for power delivery above 1.5 W. Although, the efficiency starts to degrade significantly at lower power delivery, the absolute system power loss will be low. Therefore, no heating issues have been observed during the experiment. All components operate below 36° C.

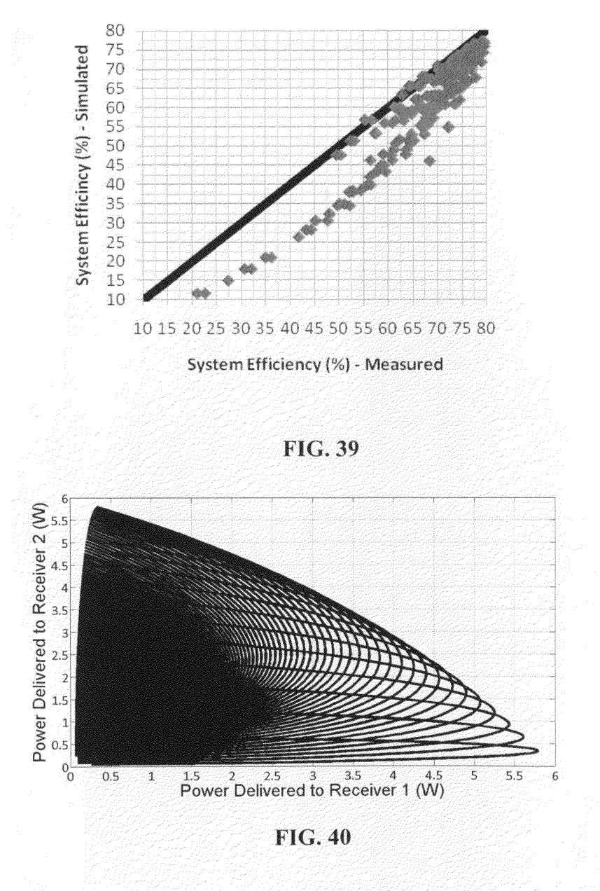

FIG. 37 compares the simulation and measured results of power delivered to receiver 1 while FIG. 38 compares the simulation and measured results of the power delivered to receiver 2. FIG. 39 compares the simulation and measured system efficiency. The simulated power delivery is lower due to the assumption that the receiver switch is ideal. This can be observed from FIG. 28, FIG. 37 and FIG. 38. It can be accounted by non-linearity of the effective capacitance of the switch (across the transistors and diodes) with respect to the voltage across it. In addition, the discrepancies become more significant when there are two receivers instead of it as each receiver will affect the power delivery to the other receiver. The results will match up better if an actual model of the switch which includes all practical models of the transistors and diodes is used. However, if an actual model is used in the Matlab simulation, it will make the simulation code more complicated that it will be better to run a full SPICE simulation. The simulated system efficiency matches closely with its measurement results at high efficiency because the operation is closer to an ideal state. The simulated efficiency results starts to deviate more at lower efficiency values where the system non-idealities are more significant. The current simulation results are sufficient to predict the trends and simulation time is typically below 30 seconds for a full dual receiver analysis using a Core2 Duo processor at 2.4 GHz.

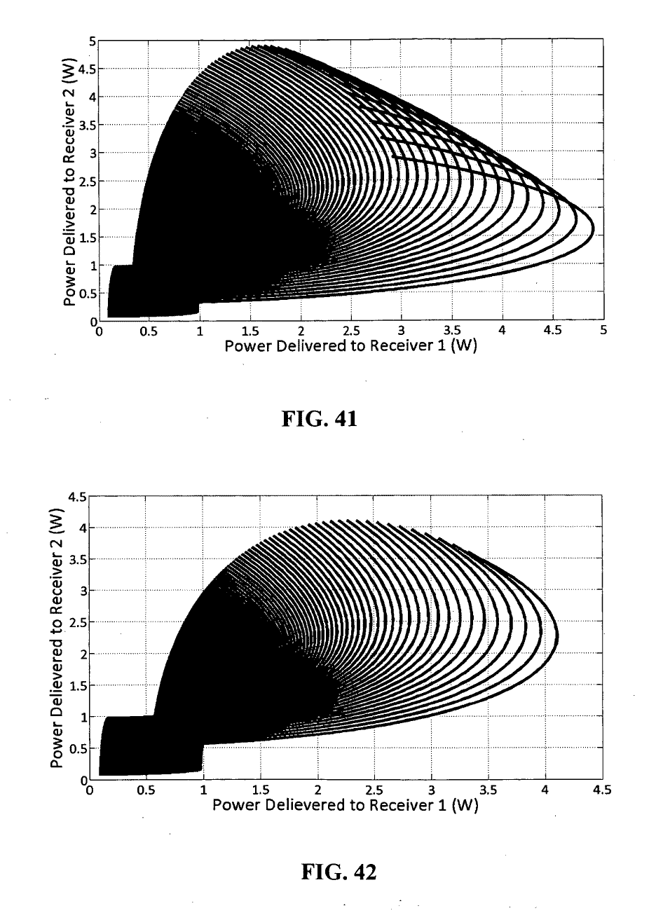

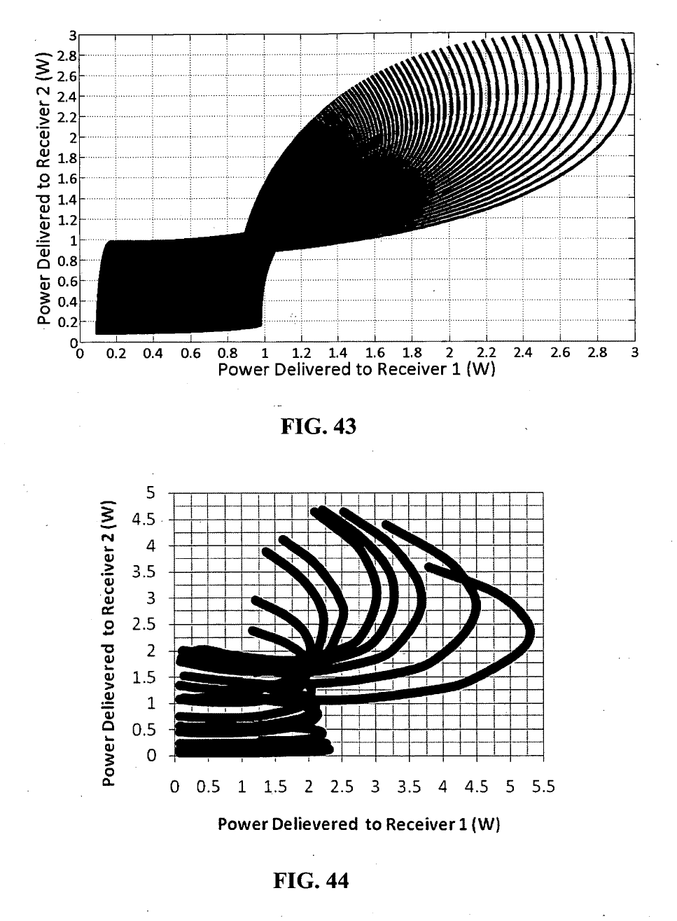

To obtain a better understanding of the power delivery to both receivers of the dual receiver setup concurrently, four different simulations are run sweeping the load resistance of each of the two receivers from a specific resistance (1Ω, 5Ω, 10Ω, 20Ω) to 1000Ω in steps of 1Ω. FIG. 40 to FIG. 43 shows the simulation results of the power delivery trend to the receivers from load resistance of 1Ω, 5Ω, 10Ω and 20Ω respectively. The lines of the plots are a result from the quantization step of 1Ω per step. A smaller step size such as 0.01Ω will results in the plots with a solid filled area rather than a series of lines, thus better reflect the actual trend. It can be seen from FIG. 40 that if the load resistance is able to go as low as 1Ω, no power “choking” phenomena is observed. However, a buck voltage regulator requires its input DC voltage to be of a certain value higher than its regulated output voltage to ensure nominal operation. For example by assuming that the regulator has an efficiency of 100% and outputs 500 mA at 5V with a minimum input voltage of 7V, the regulator will have a minimum input resistance of 19.6Ω. Therefore, a more practical power delivery trend is shown in FIG. 42 and FIG. 43. Based on the simulated results shown in FIG. 40 to FIG. 43, it is observed that under any load condition of the second receiver, it is possible to achieve 1 W of power delivery for the first receiver. It can be concluded that the dual receiver system is able to achieve a guaranteed power delivery of 1 W under all loading conditions. FIG. 44 shows the measured results of plot shown in FIG. 42 with larger step size. Although, it can be seen that both results follow the same trend but the power delivery is higher for the measured results. In addition, the guaranteed power delivery is approximately 2 W instead of 1 W. The guaranteed power delivery can also be observed in FIG. 34 in another form. Therefore, the system is capable of delivering 2 W of power under all conditions, which was close to the specified power delivery of 2.5 W in the design. Slightly higher power delivery can be achieved by using 9 nF (two 18 nF capacitors in series) for Cₒᵤₜ instead of 9.4 nF. An alternative solution is to increase the supply voltage slightly.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

### REFERENCES

[1] L. Collins, “Cutting the cord,” Electronics Systems and Software, vol. 5, Jan-December 2007.
[2] C. E. Greene, D. W. Harrist, J. G. Shearer, M. Migliuolo, G. W. Puschnigg, “Implementation of an RF power transmission and network,” U.S. Patent Application, US2007/0191075A1, Jan 23^{rd}, 2007.
[3] W. C. Brown, “The History of Power Transmission by Radio Waves,” IEEE Transactions on Microwave Theory and Techniques, vol. 32, pp. 1230-1242, September 1984.
[4] W. C. Brown, E. E. Eves, “Beamed microwave power transmission and its application to space,” IEEE Transactions on Microwave Theory and Techniques, vol. 40, pp. 1239-1250, June 1992.
[5] IEEE Std C95.1, 1999 Edition, IEEE Standard for Safety Levels with Respect to Human Exposure to Radio Frequency Electromagnetic Fields, 3 kHz to 300 GHz.
[6] Z. N. Low, R. A. Ching a, R. Tseng, J. Lin, “Design and Analysis of a Loosely Coupled Planar Wireless Power Transfer System using Magnetic Induction,” submitted to IEEE Transactions on Industrial Electronics, 6 Jul. 2008
[7] R. Laouamer, M. Brunello, J. P. Ferrieux, O. Normand, N. Bucheit, “A multi-resonant converter for non-contact charging with electromagnetic coupling,” in Proc. 23rd International Conference on Electronics, Control and Instrumentation, November 1997, vol. 2, pp. 792-797.
[8] H. Abe, H. Sakamoto, K. Harada “A non-contact charger using a resonant converter with parallel capacitor of the secondary coil,” in Proc. Applied Power Electronics Conference and Exposition, 15-19 Feb. 1998, vol. 1, pp. 136-141.
[9] G. B. Joung, B. H. Cho “An energy transmission system for an artificial heart using leakage inductance compensation of transcutaneous transformer,” IEEE Transactions on Power Electronics, vol. 13, pp. 1013-1022 November 1998.
[10] Y. Lu, K. W. E. Cheng, Y. L. Kwok, K. W. Kwok, K. W. Chan, N. C. Cheung “Gapped air-cored power converter for intelligent clothing power transfer,” in Proc. 7^{th} International Conference on Power Electronics and Drive Systems, 27-30 Nov. 2007, pp. 1578-1584.
[11] Y. Jang, M. M. Jovanovic, “A contactless electrical energy transmission system for portable-telephone battery chargers,” IEEE Transactions on Industrial Electronics, vol. 3, pp. 520-527, June 2003.
[12] C. Wang, G. A. Covic, O. H. Stielau, “Power transfer capability and bifurcation phenomena of loosely coupled inductive power transfer system,” IEEE Transactions on Industrial Electronics, vol. 51, pp. 148-157, February 2004.
[13] C. Wang, G. A. Covic, O. H. Stielau, “Investigating an LCL load resonant inverter for inductive power transfer applications,” IEEE Transactions on Power Electronics, vol. 19, pp. 995-1002, July 2004.
[14] C. Wang, O. Stielau, G. A. Covic “Design consideration for a contactless electric vehicle battery charger,” IEEE Transactions on Industrial Electronics, vol. 52, pp. 1308-1314, October 2005.
[15] G. A. Kendir, W. Liu, G. Wang, M. Sivaprakasam, R. Bashirullah, M. S. Humayun, J. D.
Weiland, “An optimal design methodology for inductive power link with class-E amplifier,” IEEE Transactions on Circuits and Systems I: Regular Papers, vol. 52, pp. 857-866, May 2005.
[16] U. Joe, M. Hgovanloo, “Design and optimization for printed spiral coils for efficient transcutaneous inductive power transmission,” IEEE Transactions on Biomedical Circuits and Systems, vol. 1, pp. 193-202, September 2007.
[17] X, Liu, S. Y. R. Hui, “An Analysis of a Double-layer Electromagnetic Shield for a Universal Contactless Battery Charging Platform,” in Proc. IEEE 36^{th} Power Electronics Specialists Conference, 16 Jun. 2005, pp. 1767-1772.
[18] X. Liu, S. Y. R Hui, “Optimal design of a hybrid winding structure for planar contactless battery charging platform,” IEEE Transactions on Power Electronics, vol. 23, pp. 455-463, January 2008
[19] G. Gwon, D. Park, S. Choi, S. Han, “Wireless charger decreased in variation of charging efficiency,” International patent application, PCT/KR2006/001706, 4^{th} May 2006.
[20] Minsik Ahn, Chang-Ho Lee, Laskar, J., “CMOS High Power SPDT Switch using Multigate Structure”, in Proc. IEEE International Symposium on Circuits and Systems, 25^{th}-27^{th} May 2007, pp. 3283-3286
[21] M. Yu, R. J. Ward, G. M. Hegazi, “High power RF switch MMICs development in GaN-on-Si HFET technology”, in Proc IEEE Radio and Wireless Symposium, 22^{nd}-24 Jan. 2008, pp. 855-585
[22] Nathan O, Sokal, “Class-E RF Power Amplifiers”, QEX, pp. 9-20, January 2001
[23] F. H. Raab, “Effects of circuit variations on the class E tuned power amplifier,” IEEE Journal of Solid-State Circuits, vol. 13, pp. 239-247, April 1978.
[24] F. H. Raab, “Idealized operation of the class E tuned power amplifier,” IEEE Transactions on Circuits and Systems, vol. 24, pp. 725-735, December 1977.

1. A circuit for switching an ac signal, comprising:
an input port, wherein the input port receives an input ac signal;
an output port;
a first transistor having a first source, a first drain, and a first gate, wherein the first source is coupled to the input port, wherein the first drain is coupled to the output port;
a second transistor having a second source, a second drain, and a second gate, wherein the second source is coupled to the input port, wherein the second drain is coupled to the output port;
a rectification network, wherein the rectification network receives the input ac signal, wherein the rectification network generates a maximum DC voltage that is approximately equal to a maximum input voltage of the input ac signal; wherein the rectification network generates a minimum DC voltage that is approximately equal to a minimum input voltage of the input ac signal;
a first control network, wherein the first control network comprises a first control port, wherein the first control port receives a first control signal, wherein the first control network receives the maximum DC voltage and the minimum DC voltage from the rectification network, wherein the first control network outputs a first transistor control signal to the first gate, wherein the first transistor control signal is the maximum DC voltage when the first control signal is in an on state, wherein the first transistor control signal is the minimum DC voltage when the first control signal is in an off state;
a second control network, wherein the second control network comprises a second control port, wherein the second control port receives a second control signal, wherein the second control network receives the minimum DC voltage and the maximum DC voltage from the rectification network, wherein the second control network outputs a second transistor control signal to the second gate, wherein the second transistor control signal is the minimum DC voltage when the second control signal is in an on condition, wherein the second transistor control signal is the maximum DC voltage when the second control signal is in an off state, wherein when the maximum DC voltage is applied to the first gate, and the minimum DC voltage is applied to the second gate, the output port is connected to the input port, wherein when the minimum DC voltage is applied to the first gate, and the maximum DC voltage is applied to the second gate, the output port is disconnected from the input port.

2. The circuit according to claim 1, wherein the first transistor and the second transistor form a transmission gate.

3. The circuit according to claim 1, wherein the output port is connected to the input port when a first control signal is not received at the first control port and a second control signal is not received at the second control port.

4. The circuit according to claim 1, further comprising:
a rectifier connected to the output port, wherein the rectifier outputs a rectified output DC signal.

5. The circuit according to claim 1, wherein frequency of input ac signal is in range of 50 kHz-500 kHz.

6. The circuit according to claim 1, wherein frequency of input ac signal is in range of 1 Hz-1 MHz.

7. The circuit according to claim 1, wherein frequency of input ac signal is in range of 1 Hz-10 MHz.

8. The circuit according to claim 1, wherein frequency of input ac signal is in range of 1 Hz-1 GHz.

9. The circuit according to claim 1, wherein the first control signal and the second control signal are lower voltage than maximum voltage of the input ac signal.

10. The circuit according to claim 1, wherein input ac signal is received from a receiver coil inductively coupled to a transmitter coil.

11. The circuit according to claim 10, wherein the coupling coefficient between the receiver coil and the transmitter coil is less than 0.5.

12. The circuit according to claim 10, wherein the coupling coefficient between the receiver coil and the transmitter coil is less than 0.25.

13. The circuit according to claim 10, wherein the coupling coefficient between receiver coil and transmitter coil is greater than 0.05.

14. The circuit according to claim 10, wherein the coupling coefficient between receiver coil and transmitter coil is greater than 0.1.

15. The circuit according to claim 1, wherein the circuit does not comprise an inductor.

16. The circuit according to claim 1, wherein the first transistor is a NMOS transistor and the second transistor is a PMOS transistor.

17. The circuit according to claim 16, wherein the NMOS transistor and PMOS transistor are in parallel.

18. The circuit according to claim 16, further comprising:
a first diode in series with the NMOS transistor in the opposite direction of a built-in diode of the NMOS transistor; and
a second diode in series with the PMOS transistor in the opposite direction of a built-in diode of the PMOS transistor.

19. The circuit according to claim 18, wherein the NMOS transistor in series with the first diode is in parallel with the PMOS transistor in series with the second diode.

20. The circuit according to claim 16, further comprising:
a second PMOS transistor in series with the NMOS transistor, wherein a built in diode of the NMOS transistor and a built in diode of the second PMOS transistor are in opposite directions of each other; and
a second NMOS transistor in series with the PMOS transistor, wherein the built in diode of the PMOS transistor and a built in diode of the second NMOS transistor are in opposite directions of each other.

21. The circuit according to claim 1, wherein the rectification network comprises:
at least one positive rectification network that rectifies the input ac signal to generate the maximum DC voltage; and
at least one negative rectification network that rectifies the input ac signal to generate the minimum DC voltage.

22. The circuit according to claim 21, wherein the rectification network comprises at least one diode and at least one charge holding capacitor.

23. The circuit according to claim 22, wherein the at least one diode is configured with a cathode of the diode connected to the input ac signal to generate the minimum DC voltage.

24. The circuit according to claim 22, wherein the at least one diode is configured with an anode of the diode connected to the input ac signal to generate the maximum DC voltage.

25. The circuit according to claim 1, wherein the first control signal and the second control signal are the same signal.

26. A receiver circuit, comprising:
a receiver coil, wherein the receiver coil is capable of inductively coupling to a transmitter coil, wherein the receiver coil comprises an output port for outputting an input ac signal;
a switch in series with the output port;
load circuitry in parallel with the series combination of the output port and the switch, wherein the load circuitry is capable of coupling to a variable load,
wherein the switch comprises:
an input port, wherein the input port receives the input ac signal;
an output port;
a first transistor having a first source, a first drain, and a first gate, wherein the first source is coupled to the input port, wherein the first drain is coupled to the output port;
a second transistor having a second source, a second drain, and a second gate, wherein the second source is coupled to the input port, wherein the second drain is coupled to the output port;
a rectification network, wherein the rectification network receives the input ac signal, wherein the rectification network generates a maximum DC voltage that is approximately equal to a maximum input voltage of the input ac signal; wherein the rectification network generates a minimum DC voltage that is approximately equal to a minimum input voltage of the input ac signal;
a first control network, wherein the first control network comprises a first control port, wherein the first control port receives a first control signal, wherein the first control network receives the maximum DC voltage and the minimum DC voltage from the rectification network, wherein the first control network outputs a first transistor control signal to the first gate, wherein the first transistor control signal is the maximum DC voltage when the first control signal is in an on state, wherein the first transistor control signal is the minimum DC voltage when the first control signal is in an off state;
a second control network, wherein the second control network comprises a second control port, wherein the second control port receives a second control signal, wherein the second control network receives the minimum DC voltage and the maximum DC voltage from the rectification network, wherein the second control network outputs a second transistor control signal to the second gate, wherein the second transistor control signal is the minimum DC voltage when the second control signal is in an on condition, wherein the second transistor control signal is the maximum DC voltage when the second control signal is in an off state, wherein when the maximum DC voltage is applied to the first gate, and the minimum DC voltage is applied to the second gate, the output port is connected to the input port, wherein when the minimum DC voltage is applied to the first gate, and the maximum DC voltage is applied to the second gate, the output port is disconnected from the input port.

27. The receiver circuit according to claim 26, wherein the variable load comprises a battery.

28. The receiver circuit according to claim 26, wherein the variable load is a battery.

29. The receiver circuit according to claim 26, wherein the load circuitry comprises two capacitors and a diode.

30. The receiver circuit according to claim 26, wherein the first control signal and the second control signal are produced by circuitry monitoring the variable load.

31. The receiver circuit according to claim 30, wherein the circuitry monitoring the variable load comprises a microprocessor.

32. The receiver circuit according to claim 30, wherein the circuitry monitoring the variable load produces an on state first control signal and an on state second control signal when the variable load is less than fully charged, wherein the circuitry monitoring the load produces an off state first control signal and an off state second control signal when the variable load is fully charged.

33. A receiver circuit, comprising:
a receiver coil, wherein the receiver coil is capable of inductively coupling to a transmitter coil, wherein the receiver coil comprises an output port for outputting an input ac signal;
a switch in parallel with the output port;
load circuitry in parallel with the parallel combination of the output port and switch, wherein the load circuitry is capable of coupling to a variable load,
wherein the switch comprises:
an input port, wherein the input port receives the input ac signal;
an output port;
a first transistor having a first source, a first drain, and a first gate, wherein the first source is coupled to the input port, wherein the first drain is coupled to the output port;
a second transistor having a second source, a second drain, and a second gate, wherein the second source is coupled to the input port, wherein the second drain is coupled to the output port;
a rectification network, wherein the rectification network receives the input ac signal, wherein the rectification network generates a maximum DC voltage that is approximately equal to a maximum input voltage of the input ac signal; wherein the rectification network generates a minimum DC voltage that is approximately equal to a minimum input voltage of the input ac signal;
a first control network, wherein the first control network comprises a first control port, wherein the first control port receives a first control signal, wherein the first control network receives the maximum DC voltage and the minimum DC voltage from the rectification network, wherein the first control network outputs a first transistor control signal to the first gate, wherein the first transistor control signal is the maximum DC voltage when the first control signal is in an on state, wherein the first transistor control signal is the minimum DC voltage when the first control signal is in an off state;
a second control network, wherein the second control network comprises a second control port, wherein the second control port receives a second control signal, wherein the second control network receives the minimum DC voltage and the maximum DC voltage from the rectification network, wherein the second control network outputs a second transistor control signal to the second gate, wherein the second transistor control signal is the minimum DC voltage when the second control signal is in an on condition, wherein the second transistor control signal is the maximum DC voltage when the second control signal is in an off state, wherein when the maximum DC voltage is applied to the first gate, and the minimum DC voltage is applied to the second gate, the output port is connected to the input port, wherein when the minimum DC voltage is applied to the first gate, and the maximum DC voltage is applied to the second gate, the output port is disconnected from the input port.

34. The receiver circuit according to claim 33, wherein the first control signal and the second control signal are produced by circuitry monitoring the load.

35. The receiver circuit according to claim 34, wherein the circuitry monitoring the load produces an off state first control signal and an off state second control signal when the variable load is less than fully charged, wherein the circuitry monitoring the load, produces an on state first control signal and an on state second control signal when the variable load is fully charged.

36. A wireless power transfer system, comprising:
a transmitter coil;
driving circuitry, wherein the driving circuitry drives the transmitter coil to produce a time-varying magnetic field;
a receiver circuit, wherein the receiver circuit comprises:
a receiver coil, wherein the receiver coil is capable of inductively coupling to a transmitter coil, wherein the receiver coil comprises an output port for outputting an input ac signal;
a switch in series with the output port;
load circuitry in parallel with the series combination of the output port and the switch, wherein the load circuitry is capable of coupling to a variable load,
wherein the switch comprises:
an input port, wherein the input port receives the input ac signal;
an output port;
a first transistor having a first source, a first drain, and a first gate, wherein the first source is coupled to the input port, wherein the first drain is coupled to the output port;
a second transistor having a second source, a second drain, and a second gate, wherein the second source is coupled to the input port, wherein the second drain is coupled to the output port;
a rectification network, wherein the rectification network receives the input ac signal, wherein the rectification network generates a maximum DC voltage that is approximately equal to a maximum input voltage of the input ac signal; wherein the rectification network generates a minimum DC voltage that is approximately equal to a minimum input voltage of the input ac signal;
a first control network, wherein the first control network comprises a first control port, wherein the first control port receives a first control signal, wherein the first control network receives the maximum DC voltage and the minimum DC voltage from the rectification network, wherein the first control network outputs a first transistor control signal to the first gate, wherein the first transistor control signal is the maximum DC voltage when the first control signal is in an on state, wherein the first transistor control signal is the minimum DC voltage when the first control signal is in an off state;
a second control network, wherein the second control network comprises a second control port, wherein the second control port receives a second control signal, wherein the second control network receives the minimum DC voltage and the maximum DC voltage from the rectification network, wherein the second control network outputs a second transistor control signal to the second gate, wherein the second transistor control signal is the minimum DC voltage when the second control signal is in an on condition, wherein the second transistor control signal is the maximum DC voltage when the second control signal is in an off state, wherein when the maximum DC voltage is applied to the first gate, and the minimum DC voltage is applied to the second gate, the output port is connected to the input port, wherein when the minimum DC voltage is applied to the first gate, and the maximum DC voltage is applied to the second gate, the output port is disconnected from the input port.

37. A wireless power transfer system, comprising:
a transmitter coil;
driving circuitry, wherein the driving circuitry drives the transmitter coil to produce a time-varying magnetic field;
a receiver circuit, wherein the receiver circuit comprises: a receiver coil, wherein the receiver coil is capable of inductively coupling to a transmitter coil, wherein the receiver coil comprises an output port for outputting an input ac signal;
a switch in parallel with the output port;
load circuitry in parallel with the parallel combination of the output port and switch, wherein the load circuitry is capable of coupling to a variable load,
wherein the switch comprises:
an input port, wherein the input port receives the input ac signal;
an output port;
a first transistor having a first source, a first drain, and a first gate, wherein the first source is coupled to the input port, wherein the first drain is coupled to the output port;
a second transistor having a second source, a second drain, and a second gate, wherein the second source is coupled to the input port, wherein the second drain is coupled to the output port;
a rectification network, wherein the rectification network receives the input ac signal, wherein the rectification network generates a maximum DC voltage that is approximately equal to a maximum input voltage of the input ac signal; wherein the rectification network generates a minimum DC voltage that is approximately equal to a minimum input voltage of the input ac signal;
a first control network, wherein the first control network comprises a first control port, wherein the first control port receives a first control signal, wherein the first control network receives the maximum DC voltage and the minimum DC voltage from the rectification network, wherein the first control network outputs a first transistor control signal to the first gate, wherein the first transistor control signal is the maximum DC voltage when the first control signal is in an on state, wherein the first transistor control signal is the minimum DC voltage when the first control signal is in an off state;
a second control network, wherein the second control network comprises a second control port, wherein the second control port receives a second control signal, wherein the second control network receives the minimum DC voltage and the maximum DC voltage from the rectification network, wherein the second control network outputs a second transistor control signal to the second gate, wherein the second transistor control signal is the minimum DC voltage when the second control signal is in an on condition, wherein the second transistor control signal is the maximum DC voltage when the second control signal is in an off state, wherein when the maximum DC voltage is applied to the first gate, and the minimum DC voltage is applied to the second gate, the output port is connected to the input port, wherein when the minimum DC voltage is applied to the first gate, and the maximum DC voltage is applied to the second gate, the output port is disconnected from the input port.

38. The system according to claim 36, further comprising:
at least one additional receiver circuit.

39. The system according to claim 38, wherein the receiver circuit and the at least one additional receiver circuit can simultaneously inductively couple to the transmitter coil.

40. The system according to claim 37, further comprising:
at least one additional receiver circuit.

41. The system according to claim 40, wherein the receiver circuit and the additional receiver circuit can simultaneously inductively couple to the transmitter coil.

42. The circuit according to claim 26, wherein the load circuitry comprises a voltage regulator.

43. The circuit according to claim 33, wherein the load circuitry comprises a voltage regulator.

44. A method for switching an ac signal, comprising:
providing an input port;
inputting an input ac signal to the input port;
providing an output port;
providing a first transistor having a first source, a first drain, and a first gate, wherein the first source is coupled to the input port, wherein the first drain is coupled to the output port;
providing a second transistor having a second source, a second drain, and a second gate, wherein the second source is coupled to the input port, wherein the second drain is coupled to the output port;
providing a rectification network, wherein the rectification network receives the input ac signal, wherein the rectification network generates a maximum DC voltage that is approximately equal to a maximum input voltage of the input ac signal; wherein the rectification network generates a minimum DC voltage that is approximately equal to a minimum input voltage of the input ac signal;
providing a first control network, wherein the first control network comprises a first control port;
providing a first control signal to the first control port, wherein the first control network receives the maximum DC voltage and the minimum DC voltage from the rectification network, wherein the first control network outputs a first transistor control signal to the first gate, wherein the first transistor control signal is the maximum DC voltage when the first control signal is in an on state, wherein the first transistor control signal is the minimum DC voltage when the first control signal is in an off state;
providing a second control network, wherein the second control network comprises a second control port;
providing a second control signal to the second control port, wherein the second control network receives the minimum DC voltage and the maximum DC voltage from the rectification network, wherein the second control network outputs a second transistor control signal to the second gate, wherein the second transistor control signal is the minimum DC voltage when the second control signal is in an on condition, wherein the second transistor control signal is the maximum DC voltage when the second control signal is in an off state, wherein when the maximum DC voltage is applied to the first gate, and the minimum DC voltage is applied to the second gate, the output port is connected to the input port, wherein when the minimum DC voltage is applied to the first gate, and the maximum DC voltage is applied to the second gate, the output port is disconnected from the input port.
